(19) United States
(12) Patent Application Publication
(10) Pub. No.: US 2016/0075601 A1
(43) Pub. Date: Mar. 17, 2016

(54) CELLULOSE NANOCRYSTAL ADDITIVES AND IMPROVED CEMENTIOUS SYSTEMS

(71) Applicants: PURDUE RESEARCH FOUNDATION, West Lafayette, IN (US); THE UNITED STATES OF AMERICA as represented by THE SECRETTARY OF AGRICULTURE, Washington, DC (US)

(72) Inventors: Jeffrey Paul Youngblood, Crawfordsville, IN (US); Pablo Daniel Zavattieri, West Lafayette, IN (US); Robert John Moon, Marietta, GA (US); William Jason Weiss, West Lafayette, IN (US); Yizheng Cao, West Lafayette, IN (US)

(73) Assignees: Purdue Research Foundation, West Lafayette, IN (US); The United States of America as Represented by the Secretary of Agriculture, Washington, DC (US)

(21) Appl. No.: 14/890,408

(22) PCT Filed: May 9, 2014
(86) PCT No.: PCT/US2014/037576

§ 371 Date: Nov. 10, 2015

Related U.S. Application Data
(60) Provisional application No. 61/822,282, filed on May 10, 2013.

(51) Int. Cl. C04B 24/38; C04B 40/00; C04B 28/04

(52) U.S. Cl. CPC C04B 24/383; C04B 28/04; C04B 40/0067

(57) ABSTRACT

The invention provides a cement paste composition comprising cement, cellulose nanocrystals, and optionally water. The cellulose nanocrystals can be present in an amount sufficient and effective to increase the flexural strength of cured cement prepared from the cement paste composition. The cellulose nanocrystals can also be present in an amount sufficient and effective to increase the workability of a cement paste prepared from the cement paste composition. The invention further provides a water reducing additive that reduces the amount of water required for desired workability of a cement composition. Use of the presence of the cellulose nanocrystals also results in an increased degree of hydration and cumulative heat evolution in comparison to a corresponding composition without the cellulose nanoparticles, thereby resulting in a higher total cure of the cement paste composition upon curing.

### RELATED APPLICATIONS

This application claims priority under 35 U.S.C. §119(e) to U.S. Provisional Patent Application No. 61/822,282, filed May 10, 2013, which is incorporated herein by reference.

### GOVERNMENT SUPPORT

This invention was made with government support under CMMI1131596 awarded by the National Science Foundation. The government has certain rights in the invention.

### BACKGROUND OF THE INVENTION

One of the new engineering frontiers is the design of renewable and sustainable infrastructure materials with novel combinations of properties that radically break traditional engineering paradigms. One promising family of materials are the nano-reinforced materials that can exhibit improvement in properties such as elastic modulus, tensile strength, flexural strength, fracture energy, and impact resistance. On one hand, nano-reinforced materials offer remarkable opportunities to tailor mechanical, chemical, and electrical properties. On the other hand, the intense research in the use of nano-reinforcements has been criticized due to perceived environmental, cost, health and safety issues. Currently, there is a growing push for “greener” products, which includes materials made from renewable and sustainable resources. In addition, there is a goal of minimizing the carbon footprint of infrastructure materials driving interest in biodegradable, non-petroleum based and low environmental impact materials. By increasing the performance of infrastructure materials, the volume of these materials that are used can be greatly reduced, thereby reducing the demand on raw materials. The use of higher performance materials is one way to ‘do more with less’.

Nano-fibers are of interest in the study of cementitious materials, among which, carbon nanotube (CNT) reinforced cement composites have been investigated in the last decade. Due to their high aspect ratio, CNTs are believed to be able to bridge microcracks thereby increasing strength. Li and coworkers showed an improvement of 25% in flexural strength and a 19% increase in compressive strength with a 0.5 wt % loading of processed multi-walled carbon nanotubes (MWCNTs) (Carbon 2005; 43(6):7; Cem. Concr. Compos. 2007; 29(5):6). Metaxa and coworkers found the presence of CNTs increased flexural strength of cement paste by 25% and improve the elastic modulus by 50% (ACI Special Publications. 2009; 267:10). However, reinforcing brittle cement matrices has been a challenge due to reinforcing materials degradation, difficulty to add a sufficient volume without causing difficulties in mixing, enabling fiber dispersion, and the high costs of the reinforcing materials.

Accordingly, there is a need for a compositions and methods to increase the strength of cement compositions. There is also a need for improved water reducing admixtures that provide cement paste compositions having increase workability.

### SUMMARY

The invention provides cellulose nanocrystals (CNCs) as additives for the improved performance of cement paste compositions and the resulting cured cement pastes. Mechanical tests of the cured cement pastes described herein show an increase in the flexural strength of approximately 20% to 50% with only 0.2% volume of CNCs with respect to cement. Isothermal calorimetry (IC) and thermogravimetric analysis (TGA) show that the degree of hydration (DOH) of the cement paste is increased when CNCs are used. Increasing the DOH increases the flexural strength of a resulting cured cement paste. The resulting cement pastes have reduced yield points and increased plasticization and workability compared to pastes prepare without the CNCs or pastes prepared with other cellulose particles. Thus, the CNCs can also be used as water reducing agents (WRAs).

Accordingly, the invention provides a cement paste composition comprising cement, optionally water, and cellulose nanocrystals. The cellulose nanocrystals can be present in an amount of about 0.04 volume % to about 5 volume %, the cellulose nanocrystals are substantially evenly dispersed throughout the cement, and the presence of the cellulose nanocrystals results in an increased degree of hydration and cumulative heat evolution in comparison to their absence, thereby resulting in a higher total cure of the cement paste composition upon curing.

In one embodiment, the length of the cellulose nanocrystals is less than about 300 nm. In some embodiments, the diameter of the cellulose nanocrystals is less than about 15 nm. In one specific embodiment, the length of the cellulose nanocrystals is less than about 220 nm and the diameter of the cellulose nanocrystals is less than about 10 nm.

In certain embodiments, the flexural strength of the composition upon curing and hardening is increased by at least 10% compared to a corresponding composition that lacks the cellulose nanocrystals, as determined by ball-on-three-ball flexural strength analysis.

In one embodiment, the flexural strength of the composition upon curing and hardening is increased by at least 20%. In another embodiment, the flexural strength of the composition upon curing and hardening is increased by at least 25%. In yet another embodiment, the flexural strength of the composition upon curing and hardening is increased by at least 30%. In a further embodiment, the flexural strength of the composition upon curing and hardening is increased by at least 40%. In a specific embodiment, the flexural strength of the composition upon curing and hardening is increased by at least about 50%.

In one embodiment, the cellulose nanocrystals are present in an amount of about 0.15 volume % to about 0.25 volume %. In various embodiments, the cement paste composition has a reduced yield point and increased plasticization and workability.

The invention also provides compositions comprising a cement paste composition as described herein, wherein the composition is concrete, self-compacting concrete, mortar, or grout.

The invention further provides methods of reducing the amount of water necessary to maintain a cement paste viscosity comprising combining cellulose nanocrystals, cement, and water, to provide a resulting composition that includes cellulose nanocrystals in an amount of about 0.04 volume % to about 5 volume %, or an amount described herein, and dispersing the cellulose nanocrystals in the cement and water, thereby providing a cement paste composition that maintains a lower viscosity relative to a corresponding cement paste composition that does not include cellulose nanocrystals. The resulting composition has increase workability compared to a corresponding composition that does not include the cellulose nanoparticles, and/or, for example, compared to a corresponding composition that does not include a polycarboxylate-based water reducing agent.

The invention also provides methods to increase the flexural strength of a cured cement composition comprising combining cellulose nanocrystals, cement, and water, to provide a resulting cement paste composition that includes cellulose nanocrystals in an amount of about 0.04 volume % to about 5 volume %, or an amount described herein, and dispersing the cellulose nanocrystals in the cement and water, thereby providing a cement paste composition that has increased flexural strength compared to a corresponding composition that does not include the cellulose nanocrystals.

The invention additionally provides methods of preparing a cement paste composition comprising combining cellulose nanocrystals, cement, and optionally water, to provide a resulting cement paste composition that includes cellulose nanocrystals in an amount of about 0.04 volume % to about 5 volume %, or an amount described herein, and dispersing the cellulose nanocrystals in the cement and water, thereby providing a cement paste composition comprising cellulose nanocrystals.

In one embodiment, the invention provides a cement composition comprising cement and cellulose nanocrystals; wherein the cellulose nanocrystals are present in an amount of about 0.04 volume % to about 5 volume %, or an amount described herein, the cellulose nanocrystals are substantially evenly dispersed throughout the cement, and the presence of the cellulose nanocrystals result in an increased degree of hydration and cumulative heat evolution when combined with water, in comparison to a corresponding composition that lacks the cellulose nanocrystals when combined with water, thereby resulting in a higher total cure of a resulting cement paste composition upon curing.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. (a) The pyramid-shaped surface serrations of plates; (b) the schematics of a testing set-up.

FIG. 2. (a) Image of the B3B fixture and a specimen. (b) Top view of the testing set-up. The dotted circles represent the three support balls beneath the disc sample.

FIG. 3. Cumulative heat of CNC-reinforced cement pastes for the first 200 hours.

FIG. 4. Seven-day TGA results from 140 to about 1100° C. with the mass at 140° C. as a base (100%). The weight loss increases with CNC volume fraction.

FIG. 5. The DOHs obtained from TGA at three ages.

FIG. 6. Water adsorption of dry CNCs with increasing relative humidity.

FIG. 7. Yield stress of CNC-reinforced cement pastes with different concentrations.

FIG. 8. Heat flow curves of the CNC-reinforced cement pastes for the first 40 hrs.

FIG. 9. BSE-SEM images of (a) reference and (b) 1.5% mixture at the age of 7 days. The 1.5% CNC mixture shows ring features surrounding the unhydrated cement cores.

FIG. 10. Optical images of (a) reference and (b) 1.5% mixture at the age of 7 days. The 1.5% CNC mixture shows ring features surrounding unhydrated cement cores.

FIG. 11. Seven-day DOHs from IC of the cement pastes with the same volume fraction of CNC and WRA. CNC mixtures exhibit higher DOHs than the WRA mixtures in all ranges.

FIG. 12. A schematics illustration of the proposed hydration products forming around the cement grain from the age of 0 to 48 hours in the (a) plain cement and (b) cement with CNCs on a portion of the cement particle showing SCD.

FIG. 13. The B3B flexural strengths of CNC-reinforced cement pastes at four different ages.

FIG. 14. The B3B flexural strengths of cement pastes with the WRA and CNC at two different ages.

FIG. 15. The relationship between B3B flexural strengths and the DOHs. The strength is increasing with DOH.

FIG. 16. Cellulose nanonmaterial terms in the proposed TAPPI Standard Terms and Their Definitions for Cellulose Nanomaterial.

FIG. 17. A schematic of the two different types of CNCs in the cement pastes.

FIG. 18. Schematic of the nanoindenation loading-holding-unloading cycle.

FIG. 19. Schematics for the tip ultrasonication.

FIG. 20. The locations chosen for the nanoindentation on the (a) topographic image; (b) gradient image on a 50 μm×50 μm area.

FIG. 21. The relationship between the shear stress and rate of CNC aqueous solutions at different concentrations.

FIG. 22. The relationship between the parameter n and CNC concentration.

FIG. 23. Shear stress-rate relationships of the CNC Ca(NO₃)₂ aqueous suspensions with CNC concentration of (a) 1.23%; (b) 2.44%.

FIG. 24. Shear stress-rate relationships of the of pore solution with CNCs.

FIG. 25. The viscosity at the strain rate of about 140 1/s for the aqueous solution and the pore solution with CNCs.

FIG. 26. The shear stress-rate relationships after ultrasonication with different durations.

FIG. 27. The shear stress-rate relationships of the CNC suspensions with and without the WRA.

FIG. 28. (a) The mass of the free CNCs per gram of cement and (b) the free CNC percentages out of all CNCs.

FIG. 29. The relationship between the reduced modulus and contact depth (a) at all three different phases; (b) at the interfacial regions.

FIG. 30. Oxygen concentration along at different phases of cement pastes (a) without CNCs and (b) with 1.5% CNCs

FIG. 31. Cumulative heat evolution during the first 200 hours of cemnet paste with (a) ultrasonicated and (b) not-ultrasonicated CNCs.

FIG. 32. Cumulative heats comparison between the cement pastes with ultrasonicated and non-ultrasonicated CNCs at the age of 7 days.

FIG. 33. Heat flow during the first 200 hours of cemnet paste with (a) ultrasonicated and (b) non-ultrasonicated CNCs.

FIG. 34. Heat flow curves of cement pastes with WRA.

FIG. 35. SEM images show multiple cracks in the (a) plain cement paste and (b) cement paste with 1.5% non-ultrasonicated CNCs.

FIG. 36. B3B flexural strengths for the cement pastes with freeze dried CNC.

FIG. 37. B3B flexural strengths for the cement pastes with CNC sonicated (a) 30 min (b) 2 hours.

FIG. 38. B3B flexural strengths of the cement pastes with the ultrasonicated CNC-WRA suspensions with WRA/CNC ratio of (a) 0.5; (b) 1; (c) 3.

FIG. 39. The relationship between the B3B flexural strengths and the DOH of the cement pastes with ultrasonicated and non-ultrasonicated CNCs at the age of 3 and 7 days.

### DETAILED DESCRIPTION

The majority of previous fiber-reinforced cement composites work, regardless of the dimension of the fibers, attributes the improvement in the mechanical performance to the mechanism of fiber bridging. Most claims are based on the fact that fibers can help delay crack propagation or even lead to crack arrest. However, the length of CNCs described herein is significantly smaller than most of the fibers used to date, and therefore, their ability to reinforce cement pastes and increase flexural strength is a surprising discovery.

This work systematically studies the effect of CNCs on cement pastes and its implications on the mechanical properties at the macroscopic level, resulting in the discovery of cement pastes with improved properties, as described herein. To investigate the CNC-cement pastes, two fundamental issues evaluated includ (1) where the CNCs are located in the cement matrix, and (2) how CNCs interact with cement particles in both the fresh state and the hardened state after setting. A series of experiments were designed and performed to study how the CNCs affect the hydration process, rheological and mechanical properties of the cement pastes, and what mechanisms are responsible for the variation in the mechanical performance. An integrated approach that combines material preparation, experiments, and microscopy to better understand the physical mechanisms that underpin CNCs use in cementitious materials is described herein.

The inventors surprisingly discovered that the addition of cellulose nanocrystals to cement in the correct amount and manner provides for improved flexural strength of the cement. For example, 0.2 volume % addition of CNCs to cement (e.g., about one cup of powder to a cement mixer truck) can increase the ball-on-three-ball flexural strength by 10-30%, and by 20-50% when ultrasonication is employed. Furthermore, the addition is characterized by an increased degree of hydration and cumulative heat evolution, and thereby results in a higher total cure of the cement. These effects occur through adsorption onto and stabilization of the cement particles to allow for better dispersion with the CNCs subsequently acting as short-circuit diffusion pathways and a type of internal curing-like behavior.

Cellulose materials have been previously added to cement compositions. However, examples of these compositions include large material having particles in the order of 2.5 microns in length and 50 nm in width. The CNCs described herein is typically about 200 nm long and 7 nm wide, and additives are not requires for the improved properties of the cement paste compositions.

### Cement Compositions and Cellulose Particles

Fiber reinforced cement composites have been studied because of the improvement in properties that can result such as improvements in Young's modulus, tensile and flexural strength, fracture energy and impact resistance. Cellulose wood fibers (WF), which has a typical dimension of >2 mm in length and 20-60 μm in diameter, is one common fiber used for cement composites for various improved properties, including crack width reduction resulting from shrinkage, reduced unit weight, increased flexural strength at both early and late ages, and toughness. However, researchers found that compressive strength of cement composites decreases with increase in fiber content, and composites with longer fibers have lower compressive strength than shorter fibers. Also, the flexural strength of cellulose fiber reinforced concrete increases with fiber volume up to an optimal fraction and then decreases.

Structure of Cellulose Particles.

A wide range of cellulose particle types can be extracted from various cellulose source materials (trees, plants, algae, bacteria, tunicates). Nine particle types are considered to comprise the main cellulose-based particles, which typically differ from each other based on cellulose source materials and the particle extraction method. Each particle type is distinct, having a characteristic size, aspect ratio, morphology, degree of branching, crystallinity, crystal structure, and properties (FIG. 16). Briefly, these particles are as follows.

1. Wood fiber (WF) and plant fiber (PF) are the largest of the particle types (20-50 μm in width, >2 mm in length), and have dominated the paper, textile and biocomposites industries for centuries.

2. Cellulose Microcrystals (CMC), more commonly referred to as microcrystalline cellulose (MCC), is prepared by acid hydrolysis of WF, back-neutralization with alkali, and spray-drying. The resulting particles are porous, ˜10-50 μm in diameter.

3. Cellulose Microfibrils (CMF), also known as microfibrilated cellulose (MFC), is produced via mechanical refining of highly purified WF and PF pulps, and are 10-1000 nm wide by 500 nm to several microns in length.

4. Cellulose Nanofibrils (CNF), also known as nanofibrillated cellulose (NFC) particles, are finer cellulose fibrils (4-20 nm wide, 500 nm to >1 μm in length) produced when specific techniques to facilitate fibrillation are incorporated in the mechanical refining of WF and PF. The differentiation of CNF from CMF is based on the fibrillation process that produces finer particle diameters but similar lengths.

5. Cellulose nanocrystals (CNC). Also known as nanocrystalline cellulose (NCC), are smaller than most other cellulose particles, and therefore have distinct properties, as further described herein.

6. Cellulose nanowhiskers (CNW), are rod-like or whisker shaped particles (3-20 nm wide, 50-500 nm in length) remaining after acid hydrolysis of WF, PF, CMC, CMF, or CNF.

7. Tunicate cellulose nanocrystals (t-CNC). Particles produced from the acid hydrolysis of tunicates are called t-CNCs. T-CNCs are differentiated from other CNCs because of differences in particle morphology (e.g., ribbon-like structures: height of ˜8 nm, width of 20-30 nm, a length of 100-4000 nm).

8. Algae cellulose particles (AC). AC particles are the microfibrils extracted from the cell wall of various algae by acid hydrolysis and mechanical refining. The resulting micmfibrils are microns in length, have a nKmrphology depending on their algae source. Valonia microfibrils have a square cross-section (˜20 nm by ˜20 nm) and Micrasterias microfibrils have a rectangular cross-section (˜5 nm by ˜20-30 nm).

9. Bacterial cellulose particles (BC). BC particles are microfibrils secreted by various bacteria that have been separated from the bacterial bodies and growth medium. The resulting microfibrils are microns in length, and a morphology depending on the specific bacteria and culturing conditions. Acetobacter microfibrils have a rectangular cross-section (6-10 nm by 30-50 nm). However, by altering the culture conditions (stirring, temperature, and additives) the BC microfibrils can be modified to have a square cross-section (˜7-10 nm cross-section).

Accordingly, the term cellulose nanomaterials (CN) is used to broadly refer to the several particle types that have at least one dimension in the nanoscale (CMF, CNF, CNC, t-CNC, AC and BC); for comparative purposes, micron and macrosized scaled particles (WF, PF, and CMC) are also defined above. While examples of the terms nanocellulose, CN, CNC, NCC, CNW, CNF, NFC, CMF, and MFC can be found to be used interchangeably in the literature, the terms are clearly defined herein to provide additional clarity.

Cellulosic nanomaterials such as cellulose nanofibrils (CNF) and cellulose microfibrils (CMF) have also been added to cementitious materials, although CNCs have not (see U.S. Patent Publication Nos. 2012/0227633 (Laukkanen et al.) and 2013/0000523 (Weerawarna et al.)). These distinctions in terminology are important because there is much inadvertent overlap in language used to describe cellulosic materials (as described above) and the only method of distinguishing various works is by identifying the actual material used. It should be noted that CNCs are chemically derived and are relatively small (˜100 nm-500 nm long and ˜5-20 nm wide), and due to stiffness acts as rigid rods, while CNF and CMF are much larger (microns to tens of microns), are heavily branched (i.e., central cellulose fibril with side arms of finer cellulose fibril structures) and flexible, and are typically produced mechanically. Each of the above described cellulosic nanomaterials can be incorporated into a cement paste of the invention (e.g., in about 0.1 volume % to about 3 volume %). However, particularly advantageous properties are obtained with the addition of CNCs to cement to form a cement paste composition.

These morphological differences create significant differences in functional behavior. While CNF and CMF show macro-cellulose behavior such as internal curing and particle bridging to increase viscosity and yield (flocculation), CNCs instead do not have internal curing and act to stabilize the particles and decrease yield. Additionally, due to this stabilization, as well as short circuit diffusion, the technology described herein (CNC addition) increases flexural strength of the final cement, whereas CNF addition does not. For example, Thomson et al (U.S. Pat. No. 8,293,003) used “NCC” of 50 nm-5 μm width and 2.5 μm-60 μm length combined with macrocellulose fibers as additives, which particles are significantly larger than the CNC nanoparticles as defined herein. Additionally, Thompson's use of a surfactant is indicative of the larger size and lack of functional dispersibility of that material, unlike the CNC described herein. This lack of dispersibility and added surfactant is likely deleterious to strength.

Weerawarna et al. and Laukkanen et al. describe “fibrillated nano or micro” cellulose, which is distinguished by being “100 nm in a dimension” and “microfibrillated” cellulose, respectively. Both are produced mechanically via a Waring blender and Refiner, respectively, and therefore both have web-like morphologies. These cellulosic materials are therefore not CNCs as defined herein (CNCs do not have web-like morphology), and they act functionally different in that they increase viscosity, show internal curing, and they do not increase cement paste flexural strength.

In this work, cellulose nanocrystals are for the first time added into cement composites to improve the mechanical performance. Other nano-fibers have been used as cellulosic reinforcement for cementitious material, but their addition to cementitious materials provide a product with different properties. Carbon nanotube (CNT) reinforced cement composites have been investigated. Due to their high aspect ratio, CNTs are believed to able to bridge nanocracks and can therefore require a larger amount of energy to propagate the cracks. However, all previous fiber-reinforced composites work, regardless of the dimension of the fibers, attributes the improvement in certain mechanical performance as the mechanism of bridging. By bridging the cracks, the fibers can arrest the further growing before they coalesce with each other and cause a failure of the materials. As described herein, the CNC reinforced cement pastes provide an improved degree of hydration (DOH), which property is found to increase with increasing concentration of CNCs. This result thus contributes to the increased mechanical performance, including increased flexural strength.

### Cellulose Nanocrystals (CNCs).

Cellulose nanocrystals (CNCs) are rod-like nanoparticles (typically 50 nm to 500 nm in length and 3-5 nm in width and 3-20 nm in height (having a square or rectangular cross-section)), and they are about 50-90% crystalline (e.g., about 60-90% crystalline or about 54-88% crystalline). They can be obtained by extraction from plants and trees followed by chemical processing. CNCs are promising nanoscale reinforcing materials for cements in that they have several unique characteristics, such as high aspect ratio, high elastic modulus and strength, low density, reactive surfaces that enable functionalization, and facile water-dispersibility without the use of surfactant or modification. CNCs can provide new options for cementitious composites for improved mechanical performance, in which the small size of CNCs allows for reduced interfiber spacing, more interactions between cellulose and the cement system, and as a result the CNCs have a greater potential to alter micro-cracking and can therefore increase the strength of the system. Additionally, other benefits of CNCs include, but are not limited to, their renewability, sustainability, low toxicity, and low cost. Moreover, CNCs are extracted from sources (e.g., plants and trees) that are themselves sustainable, biodegradable, carbon neutral, and the extraction processes have low environmental, health and safety risks (Moon R. J., Martini A., Nairn J., Simonsen J., Youngblood J., Chem. Soc. Rev. 2011; 40:54). As described herein, CNCs can be added into cementitious materials to modify the microstructures and improve the mechanical performance of the materials.

Cellulose nanocrystals (CNCs) have a unique combination of characteristics: high axial stiffness (˜150 GPa), high tensile strength (estimated at 7.5 GPa), low coefficient of thermal expansion (˜1 ppm/K), thermal stability up to ˜300° C., high aspect ratio (10-100), low density (˜1.6 g/cm³), lyotropic liquid crystalline behavior, and shear thinning rheology in CNC suspensions. The exposed hydroxyl side groups on CNC surfaces can be readily modified to achieve different surface properties (surface functionalization), which modifications can used to adjust CNC self-assembly and dispersion within a wide range of suspensions and matrix polymers, and to control interfacial properties in composites (e.g. CNC-CNC and CNC-matrix).

This unique set of characteristics results in new capabilities compared to more traditional cellulose-based particles (wood flake, pulp fibers, etc.), allowing for the development of new advanced composites that take advantage of the CNCs' enhanced mechanical properties, low defects, higher surface area to volume ratio, and engineered surface chemistries. Additionally, CNCs are a particularly attractive nanoparticle as they have low environmental-health-safety risks, are inherently renewable, sustainable, and carbon neutral, like the sources from which they are extracted, and have the potential to be processed at industrial scale quantities and at low costs.

To obtain modified properties of the CNCs and the resulting cement pastes, various amounts of the cellulose hydroxyl groups can be conjugated to or replaced by other chemical moieties such as carboxyl groups, carboxyalkyl groups, alkylsulfonic acid groups, phosphate groups, sulfate groups, and the like. The modifications thus alter the charge density of the CNC surface. For example, selective oxidation of the primary alcohol (RCH₂OH) group on the cellulose surface to a carboxylic acid (RCO₂H) provides acidic groups, which can optionally be used to couple to amine groups (RNH₂), optionally attached to other chemical moieties, forming a conjugated moiety (via an amide bond). In another example, two nearby carboxyl groups can be treated with a base to form carboxylate anions (RCO₂⁻), which in turn can be ionically bridged by a divalent cation such as Ca²⁺ or Mg²⁺. Chemical functionalization of the material can be used to optimize the properties for various applications.

### Cement Composition Embodiments.

As described above, the invention provides cement paste compositions that include cement and cellulose nanocrystals. The cement paste can also include various amounts of water, which result in improved cement compositions upon curing. The cellulose nanocrystals can be present in an amount of at least about 0.04 volume %, up to about 5 volume % or about 10 volume %, for example, to provide cement pastes with low viscosity. However, the cement pastes preferably include less than about 5 volume %, less than about 4 volume %, less than about 3 volume %, less than about 2 volume %, or less than about 1 volume %, to increase flexural strength. In some embodiments, maximal increases in flexural strength are found upon addition of CNCs at about 0.1 to about 0.5 volume %.

To optimize the properties of the compositions, the cellulose nanocrystals are substantially evenly dispersed throughout the cement. The distribution can be enhanced by sonication, including ultrasonication, to further increase the dispersion of the CNCs throughout the cement component. The presence of the cellulose nanocrystals results in an increased degree of hydration (DOH) (as determined by isothermal calorimetry (IC) and thermogravimetric analysis (TGA)) and cumulative heat evolution in a cement paste, in comparison to their absence, resulting in increased the flexural strength and a higher total cure of the cement paste composition upon curing. The resulting cement pastes have reduced yield points and increased plasticization and workability compared to pastes prepared without the CNCs or pastes prepared with other cellulose particles. Thus, CNCs can be used as a water reducing agent (WRA) (e.g., when at about 0.5 volume % or less) for cement pastes for yield point suppression, such that less water is required to obtain or maintain suitable workability of the cement pastes over a longer period of time.

The length of the cellulose nanocrystals can be about 20 nm to about 600 nm, about 50 nm to about 500 nm, about 50 nm to about 400 nm, about 50 nm to about 350 nm, about 100 nm to about 300 nm, about 200 nm to about 300 nm; or about 200 nm, about 220 nm, about 250 nm, or about 300 nm, on average. Because the cross-sectional morphology of the nanocrystals is typically square but can be rectangular, height is used to refer to the larger value when rectangular. The height of the cellulose nanocrystals can be at least about 2 nm and less than about 25 nm. The width of the cellulose nanocrystals can be at least about 2 nm and less than about 10 nm. Typically the cellulose nanocrystals are about 3 nm to about 20 nm in height, and about 3 nm to about 5 nm in width. The cellulose nanocrystals are commonly about 3-5 nm in width and about 3-10 nm in height, often about 3-10 nm in width and height. In one specific embodiment, the length of the cellulose nanocrystals is greater than about 150 nm and less than about 220 nm, and the diameter of the cellulose nanocrystals is greater than about 3 nm and less than about 10 nm.

In some embodiments, the compositions include water. In other embodiments, the compositions do not include added water. For water-based cement pastes, a suitable and effective amount of water is a water to cement ratio of about 0.35. A wide range of other ratios can be effectively employed, ranging from about 0.1 to about 0.9, or about 0.2 to about 0.8. In various embodiments, the composition does not contain a surfactant, a plasticizer, a dispersing agent, or a water reducing agent (other than the CNCs). In the compositions and methods described herein, the cement paste composition can be dry (e.g., without added water), or wet, or uncured, or cured. In further embodiments, the composition can include a surfactant, a plasticizer, and/or a dispersing agent.

By adding CNCs to cement and water, the flexural strength of the composition upon curing and hardening can be increased by at least 10% compared to a corresponding composition that lacks the cellulose nanocrystals, for example, as determined by a ball-on-three-ball flexural strength analysis. Mechanical tests of the cured cement pastes described herein show an increase in the flexural strength of approximately 20% to 50% with only 0.2% volume of CNCs with respect to cement. In one embodiment, the flexural strength of the composition upon curing and hardening is increased by at least 20%. In another embodiment, the flexural strength of the composition upon curing and hardening is increased by at least 25%. In yet another embodiment, the flexural strength of the composition upon curing and hardening is increased by at least 30%. In a further embodiment, the flexural strength of the composition upon curing and hardening is increased by at least 40%. In a specific embodiment, the flexural strength of the composition upon curing and hardening is increased by at least about 50%. At any given volume % of CNCs, the flexural strength can be increased by sonication of the fresh cement paste to increase distribution and reduce agglomeration of the CNCs throughout the composition. In a preferred embodiment, the sonication is ultrasonication (often 15 kHz to 55 kHz, typically >20 kHz)).

In various embodiments, the cellulose nanocrystals are present in an amount of about 0.1 volume % to about 1 volume %, about 0.15 volume % to about 0.5 volume %, about 0.15 volume % to about 0.3 volume %, about 0.15 volume % to about 0.25 volume %, or about 0.15 volume % to about 0.25 volume %. In one specific embodiment, the cellulose nanocrystals are present in an amount of about 0.2 volume %, ±20% of the value to account for variability in measurements. By incorporating CNCs into a cement paste, the cement paste composition has a reduced yield point and increased plasticization and workability.

The invention also provides cellulose nanocrystals (CNCs) as additives for the improved performance of cement paste compositions and the resulting cured cement pastes. The cement paste compositions can be used to provide compositions such as concrete, self-compacting concrete, mortar, or grout. The surface of the cellulose nanocrystals can be modified (e.g., with alkyl groups, carboxyalkyl groups, alkylsulfonic acid groups, phosphate groups, sulfate groups, or the like) to provide CNCs with modified properties as discussed above, that can be used in the compositions and methods described herein.

The CNCs can be used in a method to reduce the amount of water necessary to maintain a cement paste viscosity or workability, for example, when the volume % of the CNCs is at about 0.5% or less (e.g., about 0.04 volume % to about 0.5 volume %). The method can include combining cellulose nanocrystals, cement, and water, to provide a resulting cement paste composition. The composition can be formulated to include cellulose nanocrystals in an amount of about 0.04 volume % to about 5 volume %, or an amount described herein. The cellulose nanocrystals can be dispersed throughout the cement and water, thereby providing a cement paste composition that maintains a lower viscosity relative to a corresponding cement paste composition that does not include cellulose nanocrystals. The resulting composition has increased workability compared to a corresponding composition that does not include the cellulose nanoparticles.

The invention also provides methods to increase the flexural strength of a cured cement composition, methods of preparing a cement paste composition, and a cement composition comprising cement and cellulose nanocrystals; as described herein. In some embodiments, the method further comprises sonicating the combination of cellulose nanocrystals, cement, and optionally water, resulting in greater dispersion of the cellulose nanocrystals in the cement paste composition and a reduction in agglomeration of the cellulose nanocrystals. In various embodiments, the sonication comprises ultrasonication.

To prepare the cement pastes, a Type V cement can be used. However, a wide variety of cements can be used to provide suitable and effective cement pastes with improved physical properties, as described herein. Other suitable types of cement include Portland cement, energetically modified cement made from pozzolanic minerals, and Portland cement blends such as Portland blastfurnace cement, Portland flyash cement, Portland pozzolan cement, Portland silica fume cement, masonry cements, plastic cements, stucco cements, expansive cements, white blended cements, colored cements or “blended hydraulic cements”, very finely ground cements, Pozzolan-lime cements, slag-lime cements, supersulfated cements, calcium sulfoaluminate cements, natural cements, geopolymer cements, and green cements.

In some embodiments, specific examples of cement-based materials that can be used include aluminous cement, blast furnace cement, calcium aluminate cement, Type I Portland cement, Type IA Portland cement, Type II Portland cement, Type IIA Portland cement, Type III Portland cement, Type IIIA, Type IV Portland cement, Type V Portland cement, hydraulic cement such as white cement, gray cement, blended hydraulic cement, Type IS-Portland blast-furnace slag cement, Type IP and Type P-Portland-pozzolan cement, Type S-slag cement, Type I (PMY pozzolan modified Portland cement, and Type I (SM)-slag modified Portland cement, Type GU-blended hydraulic cement, Type HE-high-early-strength cement, Type MS-moderate sulfate resistant cement, Type HS-high sulfate resistant cement, Type MH-moderate heat of hydration cement, Type LH-low heat of hydration cement, Type K expansive cement, Type O expansive cement, Type M expansive cement, Type S expansive cement, regulated set cement, very high early strength cement, high iron cement, oil-well cement, concrete fiber cement deposits, or a composite material including any one or more of the above listed cements. The different types of cement can be characterized by The American Society for Testing and Materials (ASTM) Specification C-150.

Cement-based material prepared from the cement pastes described herein can include other components or fillers as known by those skilled in the art, such as those used to form various types of concretes. For example, the cement-based material can optionally include aggregates, air-entraining agents, retarding agents, accelerating agents such as catalysts, plasticizers, corrosion inhibitors, alkali-silica reactivity reduction agents, bonding agents, colorants, and the like. “Aggregates” as used herein, unless otherwise stated, refer to granular materials such as sand, gravel, crushed stone or silica fume. Other examples of aggregate materials include recycled concrete, crushed slag, crushed iron ore, or expanded (i.e., heat-treated) clay, shale, or slate.

### DEFINITIONS

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a component” of a cement paste includes a plurality of such components, so that a component X includes a plurality of components X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrase “one or more” is readily understood by one of skill in the art, particularly when read in context of its usage. Any open ended range can, if appropriate in the context of its usage, be viewed as having closed end at about twice, about 10 times or about 100 times the recited value.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values, e.g., weight percentages, proximate to the recited range that are equivalent in terms of the functionality of the individual ingredient, the composition, or the embodiment. The term about can also modify the end-points of a recited range as discuss above in this paragraph.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, or ranges made from combining specific values recited herein, as well as the individual values making up the range, particularly integer values. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for components and ranges of amounts thereof, are for illustration only; they do not exclude other defined values or other values within defined ranges.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the molecular level, for example, to bring about a chemical reaction, or a physical change, e.g., in a solution, or in a reaction mixture.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture (e.g., a cement paste or cured cement paste). Thus, an “effective amount” generally means an amount that provides the desired effect.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### Examples

### Example 1

### Influence of Cellulose Nano Crystal Addition on Cement Paste Performance

The influence of cellulose nanocrystal (CNC) addition on the performance of cement paste was investigated. Our mechanical tests show a typical increase in the flexural strength of approximately 30% with only 0.2% volume of CNCs with respect to cement. Isothermal calorimetry (IC) and thermogravimetric analysis (TGA) show that the degree of hydration (DOH) of the cement paste is increased when CNCs are used. A first mechanism that explains the increased hydration is steric stabilization, which is the same mechanism by which many water reducing agents (WRAs) disperse the cement particles. Rheological, heat flow rate measurements, and microscopic imaging support this mechanism. A second mechanism also supports the increased hydration, which mechanism is referred to as short circuit diffusion. Short circuit diffusion appears to increase cement hydration by increasing the transport of water from outside the hydration product shell (i.e., through the high density CSH) on a cement grain to the unhydrated cement cores. The DOH and flexural strength were measured for cement paste with WRA and CNCs. The results indicate that short circuit diffusion is more dominant than steric stabilization.

Materials and Experimental Testing Procedures.

CNC-cement paste composites described herein were prepared by mixing CNC suspensions, water and cement powder to obtain mixtures with different concentrations of CNC to provide various CNC-cement paste mixtures. After preparing the CNC-cement paste mixture, three main aspects of the resulting material were investigated: (1) the curing process, (2) the mechanical properties and (3) the microstructure. While IC and TGA were used to determine the DOH of cement pastes; zeta potential, water adsorption and rheological measurements were used to investigate the interaction and affinity of CNCs with cement particles. Additionally, a ball-on-three-ball (B3B) flexural testing was performed to measure the flexural strength of the cement pastes at four different ages.

Cement Pastes Preparation.

A Type V cement was used in this investigation due to its compositional purity (i.e., low aluminates and ferrite phases), the Bogue compositions and Blaine fineness of which are shown in Table 1. Increases in the favorable properties described herein can be achieve using other types of cement as well.

TABLE 1
Bogue compositions of Type V cement.

| | |
|---|---|
| C₃S (%) | 63.8 |
| C₂S (%) | 13 |
| C₃A (%) | 0 |
| C₄AF (%) | — |
| C₄AF + C₂F (%) | 12.6 |
| Blaine fineness, m²/kg | 316 |

The CNC materials were manufactured and provided by the USDA Forest Service-Forest Products Laboratory, Madison, Wis. (FPL). The CNCs were extracted via sulfuric acid hydrolysis of Eucalyptus dry-lap cellulose fibers, resulting in a 0.81 wt. % CNC surface-grafted sulfate content. The as-received CNC materials were in the form of a dispersed suspension (5.38 wt. % CNCs in water).

The cement pastes were mixed with a vacuum mixer (Twister Evolution 18221000 from Renfert USA Inc.). The mixer is programmable for consistency and provides a low vacuum environment during cement mixing which can help reduce the entrained air that may develop in mixtures. The following procedure was used for the preparation of the cement pastes: (1) the cement, CNC suspension and water were measured in the mixer bowl; (2) the mixer was set to mix at a speed of 400 rpm for 90 seconds; (3) a spatula was used scrape the wall and bottom of the bowl (this typically lasted 15 seconds); (4) another 90 seconds of mixing was done at 400 rpm. After the mixing was complete, the fresh cement pastes were cast in plastic cylinders (5.1 cm in diameter and 10.2 cm in height) and sealed at 23±1° C. for curing.

At the age of 24±1 hours, the cylinder samples were demolded and cut with a water saw into disc specimens with thickness of about 0.7 cm. To avoid end effects, the two end pieces were discarded. Any excess of moisture on the surface was removed with a towel and the specimens were sealed in plastic bags at 23±1° C. until the age of testing. Table 2 shows a summary of the cement pastes that were tested along with CNC concentrations. The CNC concentrations were calculated based on their volume fraction with respect to cement. To avoid confusion, both the quantities in mass and volume are listed in the table. Cement pastes were prepared at a water to cement ratio (w/c) of 0.35 with seven different CNC concentrations. For consistency, discussion herein is based on this volume fraction, although similar results can be obtained with a variety of water to cement ratios.

TABLE 2
Experimental matrix for CNC-reinforced cement pastes (CP)

| | | | | | | | CNC/ |
|---|---|---|---|---|---|---|---|
| Mixture | wt (g) | | | vol (cm³) | | | cement |
| Number | cement | water | CNC | cement | water | CNC | vol % |
| CP-1 | 500 | 175 | 0.000 | 160.3 | 175 | 0.000 | 0.000% |
| (reference) | | | | | | | |
| CP-2 | 500 | 175 | 0.103 | 160.3 | 175 | 0.064 | 0.040% |
| CP-3 | 500 | 175 | 0.256 | 160.3 | 175 | 0.160 | 0.100% |
| CP-4 | 500 | 175 | 0.513 | 160.3 | 175 | 0.321 | 0.200% |
| CP-5 | 500 | 175 | 1.282 | 160.3 | 175 | 0.801 | 0.500% |
| CP-6 | 500 | 175 | 2.564 | 160.3 | 175 | 1.603 | 1.000% |
| CP-7 | 500 | 175 | 3.846 | 160.3 | 175 | 2.404 | 1.500% |

Isothermal Calorimetry.

To obtain the degree of hydration (DOH) of the cement pastes, the heat flow rate and cumulative heat release were measured with a TAM Air isothermal calorimeter. Immediately after mixing, 25 to 35 g of the paste sample was transferred to a glass ampoule (22 mm in diameter and 55 mm in height), which was then sealed and placed into the chamber (maintained at 23±0.1° C.) for measurement. Before the data collection started, the isothermal condition was held for 45 min to reach equilibration and the subsequent steady heat measurement was performed for approximately 200 hours.

Thermogravimetric Analysis.

The thermogravimetric analysis (TGA) was performed using a TA Instruments SDT 2960 Simultaneous DTA-TGA instrument as a complimentary method to obtain the DOH of CNC-cement pastes at three different ages: 7, 14 and 28 days. At the ages of testing, the paste samples were demolded from the sealed plastic containers and ground into powders with mortar and pestle while evaporation was minimized, and approximately 65 mg of powder was transferred into the TGA chamber for measurement.

First the temperature in chamber was increased from ambient temperature to 140° C. (approximately the critical temperature) by 20° C./min. For the second step the chamber was kept at 140° C. for 25 minutes to remove the evaporable water in the sample. Subsequently, the sample was heated, from 140° C. to 1100° C. at a rate of 20° C./min, to extract all chemically bound water (CBW). TGA was performed to obtain the DOH because at later ages the heat release rate from IC is small and the measuring error under such conditions becomes significant. The TGA measurements were also performed on the individual materials of CNC and cement for corrections.

Zeta Potential.

The zeta potential is the potential between the liquid layer adjacent to the solid phase and the liquid layer constituting the bulk liquid phase [14] and is a measure of the magnitude of the electrostatic repulsion or attraction between particles [15, 16]. In this work, the zeta potentials of the CNC and cement particles were measured to investigate the affinity between them in the fresh cement paste from the point of view of colloidal chemistry. The measurements were taken with a Zetasizer Nano ZS equipment from Malvern Instruments Ltd. [17]. The CNC and cement particles were, respectively, diluted in DI water or simulated pore solution (introduced in later section) to a concentration of about 0.2 wt % for measurements.

Water Adsorption.

Due to the high surface area of CNCs, the adsorption of water can result in a lowered effective water to cement ratio (w/c) in cement mixing and hence a change in the rheological properties of the fresh CNC-cement paste. To study this possible effect, the water adsorption for the dry CNC materials was measured with an absorption/desorption device (Dynamic vapor sorption analyzer Q5000 SA from TA instruments). The CNC film was obtained by allowing the CNC suspension to dry in an oven at 50±2° C. for 24 hours. After the film was weighed, the film was kept in the oven at the same temperature for another 12 hours leading to a mass change of less than 0.5%. The CNC film was then allowed to dry for 36 hours in the desorption analyzer at 0% relative humidity (RH). After an initial equilibrium period, the initial RH in the chamber was increased to 97.5% in steps of 10% increments, with a final step of 7.5%.

Rheology.

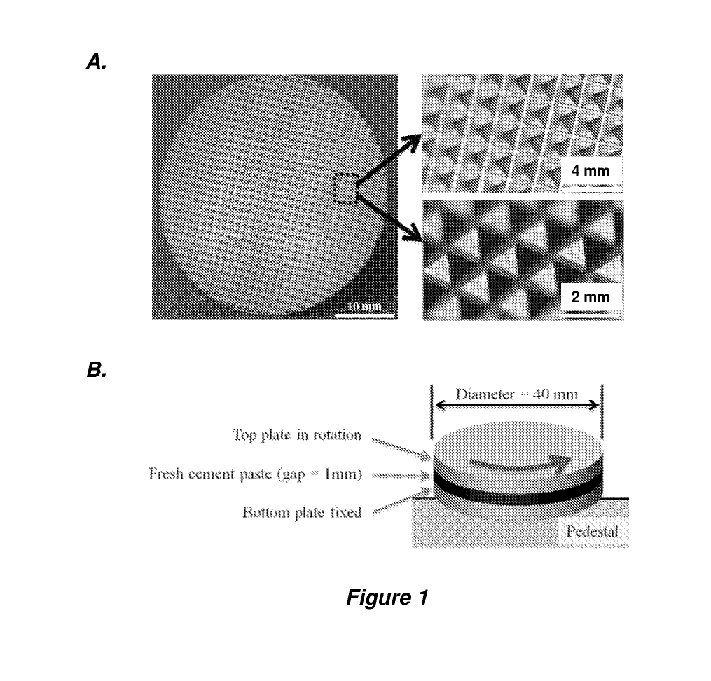

The rheological behavior was measured with a Bohlin Gemini HR nano rheometer from Malvern Instruments Ltd. The testing geometry consisted of two 40-mm parallel plates with serrated surface, which helped avoid slippage (Ferraris et al., J. Adv. Conc. Tech. 2007; 5(3):9), separated with a gap of 1 mm. FIG. 1 shows the nominal surface geometry of the plates and the testing set-up with the fresh cement paste sample.

All tests were started at an age of about 12±1 min. As the cement pastes are in the dormant period it is expected that the material behavior does not change significantly during the testing period due to hydration. A cover was placed around the fresh cement during the test to mitigate the edge drying/water evaporation. The five mixtures with low CNC concentration (0 to 0.5 vol. %) were measured with a shear stress controlled ramp from 5 to 200 Pa in 6 minutes with a logarithmic increase. The two systems with high CNC concentrations (1.0 and 1.5 vol. %), had a much higher yield stress than the previous five, therefore the testing ramp was set from 20 to 1000 Pa, also in 6 minutes with a logarithmic increase.

Optical and Scanning Electron Microscopy.

To further investigate the interaction between CNCs and cement matrix and to obtain direct evidence of the CNC locations in the cement matrix, optical and backscattered scanning electron (BSE-SEM) microscope images of hardened cement pastes were obtained and investigated. The samples were demolded at the age of 7 days and cut into 2 cm×2 cm×0.5 cm specimens with a water cooled diamond tipped saw blade, and subsequently soaked in acetone for 48 hours to replace the pore water and cease hydration. After oven-drying at 55° C. for 24 hours, the samples were epoxy-saturated at low vacuum for 4 hours and the epoxy solidification was done at 70° C. for 8 hours. The BSE-SEM imaging requires a flat surface, therefore the epoxy-impregnated samples were cut with a low-speed oil saw to expose a fresh surface and a polishing procedure was conducted on the sample surfaces using 15, 9, 3, 1, 0.25 μm diamond paste for 4 minutes each on top of Texmet paper. The polished samples were first imaged with an Olympus BX51 optical microscope, and then coated with gold/palladium for subsequent BSE-SEM imaging using an FEI Quanta 3D FEG equipment.

Ball-on-Three-Ball Flexural Test.

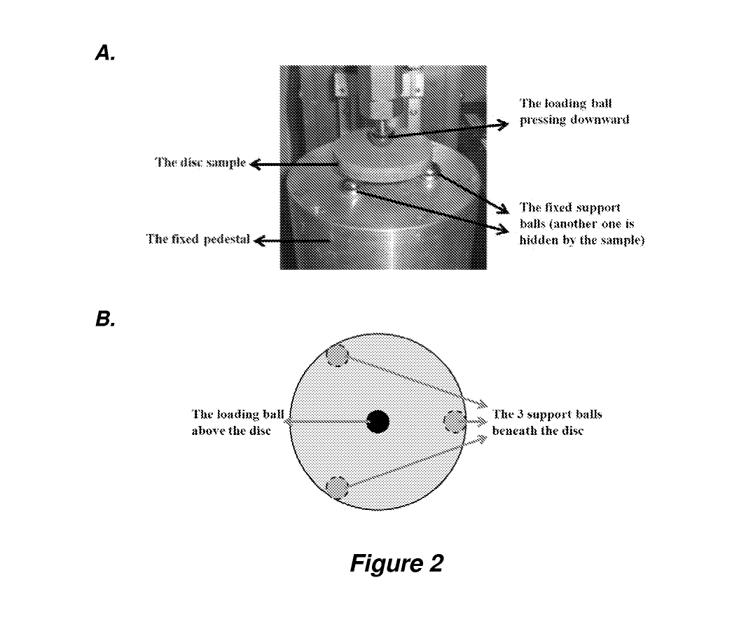

The characterization of the flexural strength of the cement pastes was carried out with a multi-axial ball-on-three-ball (B3B) flexural test. In this testing set-up, the load is given by one ball pressuring downward at the center of the disc sample. Three ball supports are located beneath the sample in the corners of an equilateral triangle. FIG. 2(a) shows a photo of one sample being tested with this fixture. There are several advantages of the B3B flexural tests over other, more traditional, flexural tests performed on beam specimens (Konsta-Gdoutos et al., Cement & Concrete Composites 2010; 32(2):6). For instance, the B3B flexural test requires round-disk samples, which can be easily obtained in large quantities from sectioning a cylinder. The geometry and loading conditions generate a state of biaxial tensile state in the center of the specimen, that makes it more sensitive to defects in all the in-plane directions of the disk (see Seitz et al., J. Amer. Ceramic Soc. 2009; 92(7):7). For example, longitudinal cracks are not likely to be detected in three- or four-point bending tests because of their orientation with respect to the tensional direction (Lee et al., Mat. Lett. 2002; 56:8).

The flexural B3B strength was obtained by the following expression derived by Börger et al. (J. Eur. Ceramic Soc. 2004; 24:12):

$$σ = f ( α , β , v ) \frac{F}{{t}^{2}}$$

where σ is the B3B flexural strength, α and β the geometry parameters, v the Poisson's ratio, F the peak load, t the sample thickness.

### Results and Discussion

### Degree of Hydration.

Because cement hydration is an exothermic reaction, the rate of heat flow (dQ) and cumulative heat evolution (Q) measured in the cement can be directly related to the rate of hydration and degree of hydration (DOH). The DOH was estimated by the ratio Q/Q_{∞}, where Q represents the cumulative heat released before a certain age and Q_{∞} is the theoretical amount of cumulative heat when the cement is fully hydrated. Q_{∞} can be obtained by multiplying the theoretical value of each hydration component (C₃S, C₂S, C₃A, and C₄AF) with the proportion of each component (Barnes and Bensted; Structure and Performance of Cements. Second ed. New York: Spon Press, Taylor & Francis Group; 2002).

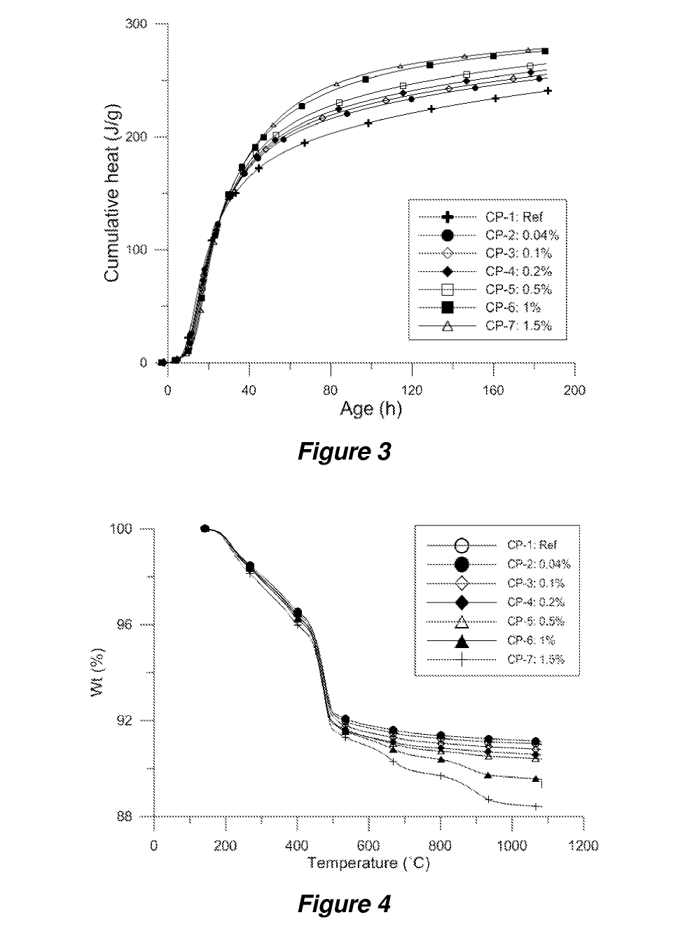

With the measurements of isothermal calorimetry (IC) described above, FIG. 3 shows the results of the cumulative heat for the first 200 hours of the seven mixtures with different CNC concentrations. After the first 25 hours, the cumulative heat increases with the CNC concentration. This trend continues until the end of the test (at an age of 200 hours) where the increase of cumulative heat with CNC content prevails. The cumulative heat for the mixture with 1.5% of CNC at 200 hours is 280 J/g, which is about 16% higher than that of the reference mixture (without CNC) at the same age. This indicates that the DOH of the cement paste is increasing with the CNC additions. It is noteworthy that during the first 25 hours the cumulative heat shows an opposite trend that, with more CNCs the mixture has less heat release at a certain age. This retardation may be caused by the CNCs adhering on the cement particles and reducing the reaction surface area between cement and water. As a result, the hydration is slowed in comparison to the surface in the plain system (similar to observations with some water reducing admixtures).

The DOH can also be estimated by measuring the total mass of the chemically bound water (CBW) in the hardened cement pastes with thermogravimetric analysis (TGA). The TGA tests were performed for (i) pure cement and (ii) dry CNC films for correcting the weight loss from the CBW. FIG. 4 shows the weight loss after corrections between 140 and 1100° C. with the mass at 140° C. as the base (100%). These results clearly show that the weight loss of the CNC-cement paste is increased with increasing concentrations of the CNC. For example, the reference sample has a final weight of 91.8% while the 1.5 vol % mixture is 88.4% and the weight loss difference between these two samples is 3.4%. This means that more water reacts with cement when the CNCs are present at any given age. This evidence, together with the IC results, supports that CNCs help to improve the DOH of the cement pastes. Two interesting features shown by FIG. 4 are that (1) the decrease in mass observed between 440° C. and 520° C. correlates with the decomposition of Ca(OH)₂; and (2) the weight loss differences between the seven mixtures after about 500° C. are much higher than before this temperature. This characteristic is nontrivial and may be directly related with the mechanism of the DOH improvement, discussed below (The interaction between CNCs and cement particles section).

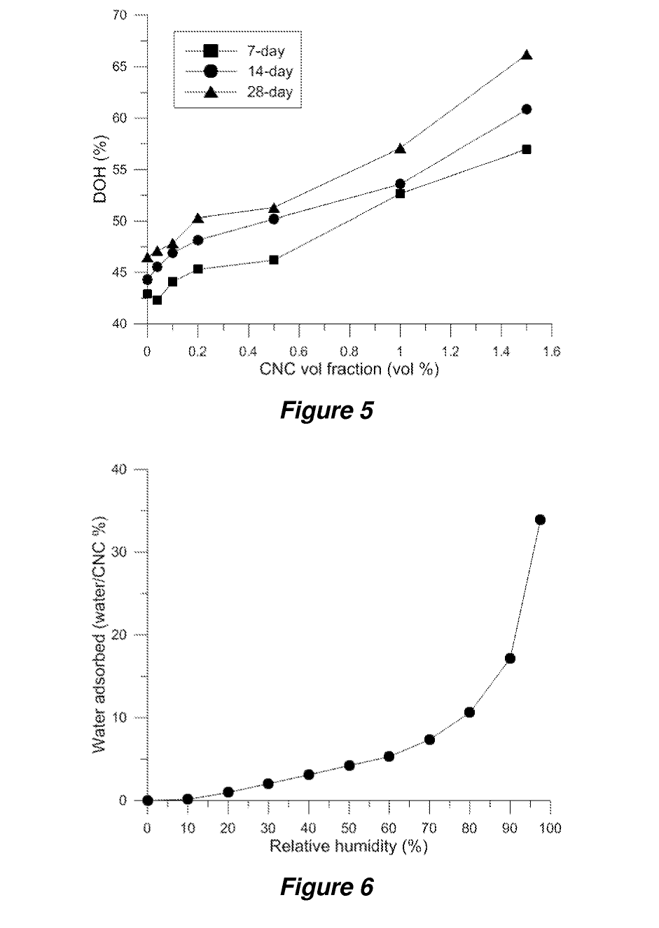

DOH is calculated with the method introduced by Pane and Hansen (Cement and Concrete Res. 2005; 35(6):10) that states that the weight loss between 140 and 1100° C. is considered as the amount of CBW, which is divided by the final weight the material to obtain the mass of CBW per unit gram of unhydrated cement. With the assumption that the CBW is 0.23 g per unit gram of cement when fully hydrated (Mater. Res. Soc. Symp. Proc. 1987; 85:8), the DOH can be easily obtained by dividing the mass of CBW per unit gram of unhydrated cement with 0.23 g. FIG. 5 summarizes all DOHs at the three different ages from TGA measurements, from which it can be observed that the DOHs for cement pastes with 1.5 vol. % of CNC are improved with respect to the reference case (0%) by 14%, 16%, and 20% for 7, 14 and 28 days, respectively.

One explanation for the improvement in DOH with CNC additions at the same w/c ratio is that the CNCs enable the cement particles to more efficiently react with water. This can be due to steric stabilization, which is the same mechanism observed in some types of water reducing admixtures (WRA) (e.g., polycarboxylated based) to disperse cement particles during cement mixing resulting in finer and more uniform distributions of cement.

The Interaction Between CNCs and Cement Particles.

To understand how CNCs interact with cement particles it is important to determine where the CNCs are located in the cement matrix. A series of experiments was performed to achieve this determination.

Water Adsorption.

Following the method and the experimental details described above in the Water adsorption section, the water adsorption with relative humidity (RH) was measured for dry CNC films; results are shown in FIG. 6. The mass of water adsorbed is plotted with respect to the CNC film mass. At the RH of 97.5%, which can be considered as the environment in which CNCs are immersed in water, the water adsorption is 34%. This amount is considered negligible in cement mixing. For example, for the mixture with 1.5% of CNC, the adsorbed water is only about 0.7% of the total mixing water in mass. As the water adsorption is only an insignificant amount, the effect of the affinity between CNC and water can be disregarded when analyzing the rheological properties of fresh mixtures.

Rheological Properties.

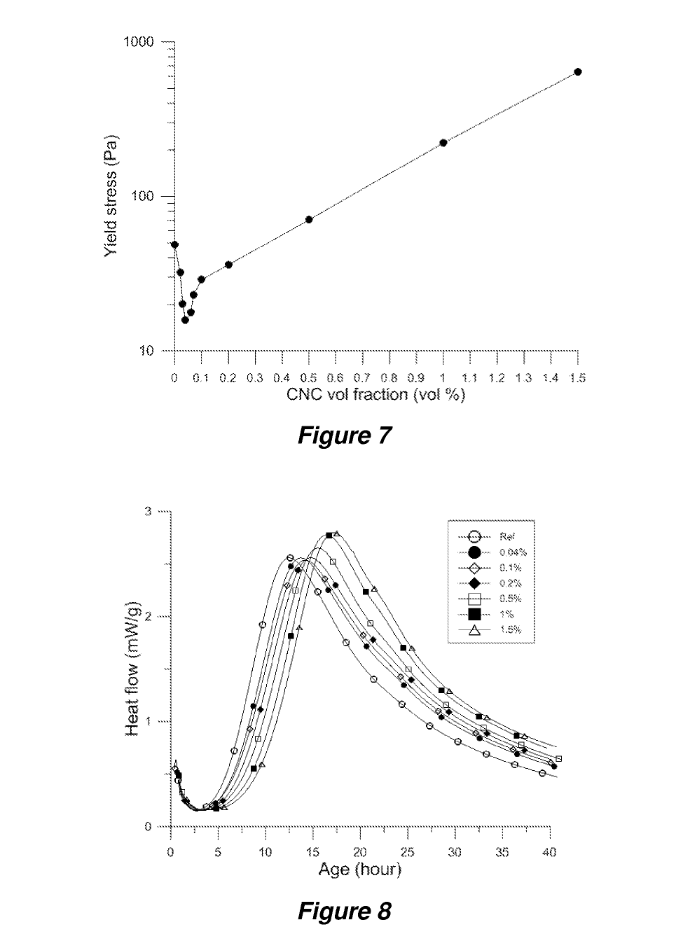

The yield stress of the mixtures is obtained with the rheological experiments using the testing geometry and parameters described in the Rheology section above. For this tests, eleven different mixtures were measured, four more mixtures than those described in Table 2. These extra mixtures (i.e., 0.02% 0.03%, 0.06% and 0.07%) were added to investigate the yield stress in the low CNC concentration region. FIG. 7 summarizes the yield stress of fresh cement pastes with different CNC/cement volume fractions, among which the reference sample (0% CNC) has a yield stress of 48.5 Pa. The trend observed here is that the yield stress decreases with increasing CNC content from the plain mixture and reaches a minimum 15.9 Pa at a concentration of 0.04% and then increases with further increasing the CNC additions. At approximately 0.3% CNC, the yield stress reaches the initial yield stress for the reference case. For CNC concentrations higher than 0.3%, the stress increases dramatically reaching values of up to 600 Pa for a conc. of 1.5%.

There are two dominant mechanisms that can be responsible for the trend of the decrease and increase in the yield stress. On one hand, the decrease of yield stress at low concentration of CNC can be due to the steric stabilization, a mechanism that has also been observed with water reducing admixtures. On the other hand, the increase in yield strength at high CNC concentrations is likely due to the agglomeration of CNCs in the fresh cement paste pore solution. The yield stress increases as the CNCs form a network and require larger forces to break or align them. As a result, the changes in yield stress of cement pastes with CNCs could be explained by a combined effect of steric stabilization and agglomeration. When the concentration is low (e.g., below 0.3%), steric stabilization dominates, while the agglomeration determines the yield stress after the concentration is much higher (e.g., higher than 0.3%).

Isothermal Calorimetry.

Cement hydration is a sum of chemical reactions between cement and water. If a third type of nonreactive materials adhere onto the cement particles, reducing their reactive surface, the hydration process may be affected. A direct way to monitor the extent of reaction is to measure the heat flow rate with IC (which can be obtained as the derivative of the cumulative heat versus age shown in FIG. 3). FIG. 8 shows the heat flow curves for the seven CNC-cement pastes during the first 40 hours, from which it can be observed that the heat flow is delayed with increasing CNC concentrations. For instance, the heat flow peak is reached at the age of about 12 hours for the reference mixture (0%) while the peak is reached at around 17 hours for the mixture with 1.5% CNC. The retardation of the peak heat flow can be an indication of CNCs adhering to the cement particles and, therefore, blocking the cement particles from reacting with water at early age. A similar observation is made with some WRAs where the DOH is improved at later ages, while the hydration is delayed at early ages.

Optical and Scanning Electron Microscopy.

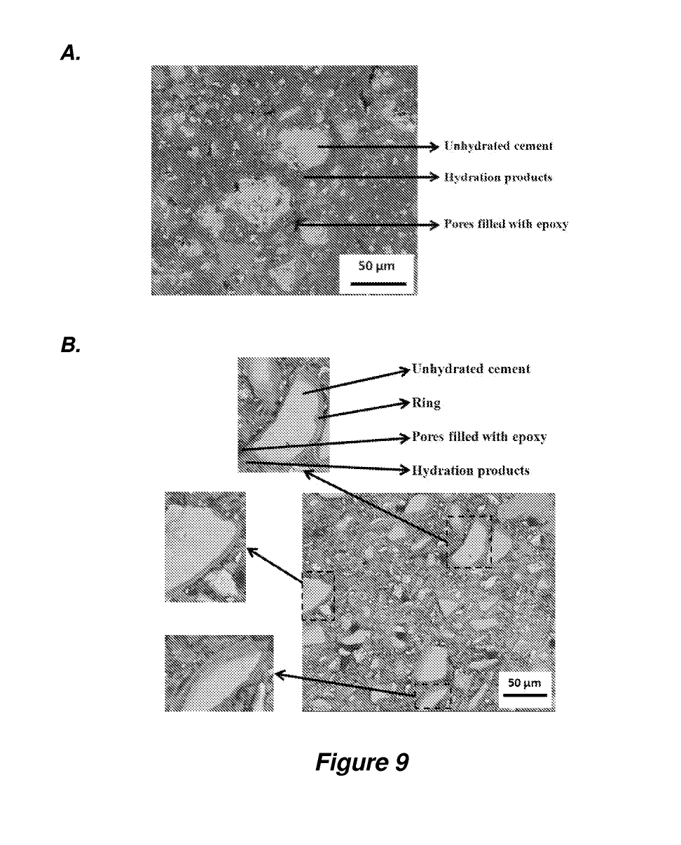

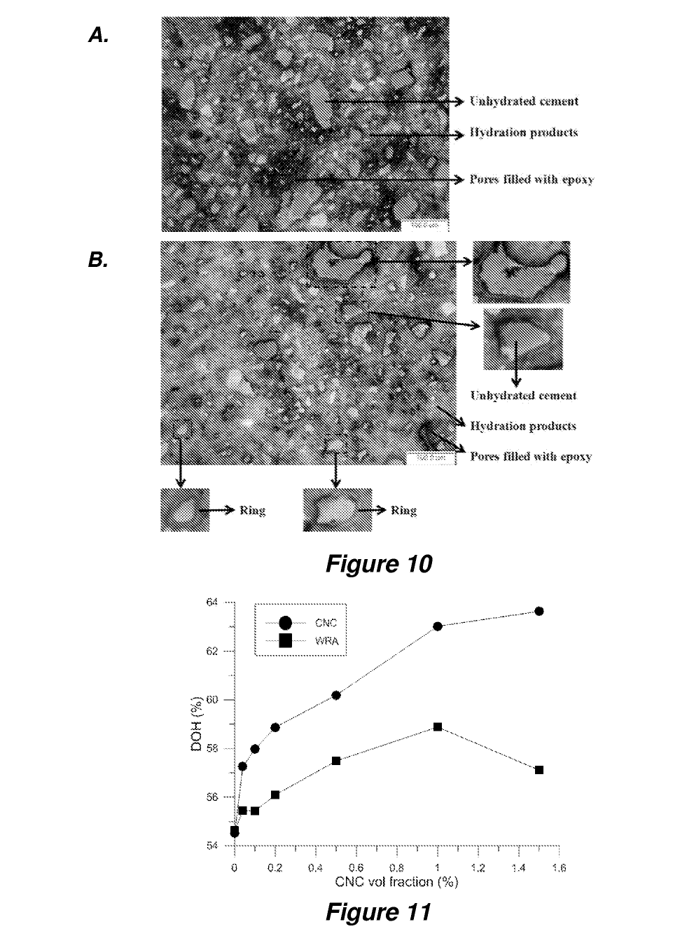

To further investigate the locations of CNCs in the cement matrix and to obtain visual evidence, imaging was taken for hardened cement pastes with and without CNCs. The hardened cement pastes were epoxy-impregnated and polished following the procedure described above. Both the BSE-SEM and optical images were taken for the reference and the 1.5% mixture to capture the features related with CNCs. FIG. 9 is a comparison between the BSE-SEM images of the reference (a) and the 1.5% CNC cement paste (b) at the age of 7 days, where the 1.5% CNC mixture shows ring features surrounding the unhydrated cement cores. FIG. 10 shows optical images of reference (a) and 1.5% mixture (b) at the age of 7 days, where the 1.5% CNC mixture shows ring features surrounding unhydrated cement cores.

Comparing the images of the reference and the 1.5% mixtures, one interesting feature shown by the CNC cement pastes is that a ring or shell formed around many unhydrated cement particles, which are highlighted and zoomed in FIGS. 9 and 10. As discussed in previous sections, the CNCs tend to adhere to the cement particles, which ultimately leads to steric stabilization effects. As a result, the concentration of CNCs around the cement particles is expected to be higher than that in the hydration product, which can explain the presence rings in the 1.5% mixture.

Zeta Potential.

In colloidal chemistry, the zeta potential of different particles indicates the degree of repulsion or attraction in a dispersion. As the zeta potential is susceptible to variations of pH values, the investigation was carried out in a controlled pH environment. Two different values of pH were evaluated: a neutral environment with a pH of 7, and the fresh cement with a pH of 12.71.

As such, a simulated pore solution was prepared with the composition described by Rajabipour et al. (Cement & Concrete Res. 2008; 38(5): 10) at the age of 1 hour, diluted with deionized water to achieve a pH of 12.71 for the zeta potential measurements. The zeta potentials for the CNC and cement particles at the two different pH environments (neutral and as-measured fresh cement pH (12.71)) are listed in Table 3.

TABLE 3
The zeta potentials of CNC and cement particles.

| Environment (pH) | Cement | CNC |
|---|---|---|
| DI water (7) | −10.4 mV | −64.0 mV |
| Pore solution (12.71) | −9.1 mV | −51.0 mV |

As these results show, the pH does not significantly change the zeta potential and the absolute value of the zeta potential for cement is much lower than that of CNC, which means that compared with CNC, cement particles have a much stronger tendency to agglomerate. The affinities between the particles have following order:

f(cement−cement)>f(cement−CNC)>f(CNC−CNC)

In other words, CNCs tend to adhere onto cement particles rather than to agglomerate themselves, which is consistent with the mechanism of steric stabilization that an affinity between CNC and cement particles is required. However, this mechanism also indicates that the CNCs should be relatively dispersed and able to separate the cement particles from each other. While the zeta potential results show that the affinity between cement particles is stronger than that between cement and CNC, the steric stabilization might not be the dominating mechanism in this system. To verify this, a polycarboxylate-based WRA (ADVA 140) was chosen for its dispersion mechanism of steric stabilization to make a parallel comparison with the CNC-cement pastes. The first parameter compared is the DOH; the cement pastes with the same amount (volume fraction) of CNC and WRA were tested with IC, and the results are plotted in FIG. 11. The CNC mixtures exhibit higher DOHs than the WRA mixtures in all compositional ranges.

The results show that the improvement of DOH achieved by the presence of WRA is lower than that caused by CNC. For instance, 1 vol % content of WRA exhibits an increase in DOH of only 4% with respect to the reference case, while the increase in DOH for 1 vol % of CNC is about 8%. It should also be mentioned that the DOH decreases when the WRA is increased from 1% to 1.5%. This is likely due to the excess WRA causing a significant segregation of cement in water. Considering that the main function of WRA is steric stabilization, this indicates that steric stabilization is likely not the only mechanism responsible for the improvement of DOH.

It is well known that, during curing, the hydration product forms a shell around the unhydrated cement particle (i.e., the high density CSH), slowing down the diffusion of water to its interior. This phenomenon limits the hydration rate and, as a result, the cores of the cement particles hydrate slowly. When CNCs are present in the cement paste, CNCs can initially adhere to the cement particles and remain in the hydration product shell (i.e., the high density CSH), and they can form a path to transport water from the pore water to the inner unhydrated cement core. This can facilitate a larger portion of cement reacting with water compared with the cement pastes without CNCs.

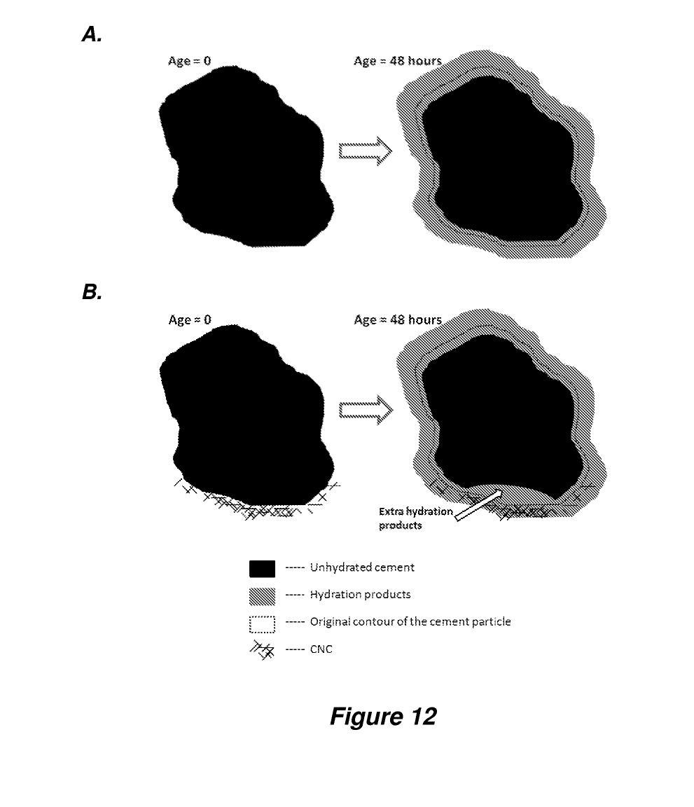

The mechanism of water molecules diffusing along the CNC networks in the hydration products shell is referred as short-circuit diffusion (SCD). FIG. 12 shows a conceptual illustration of how SCD help the cement particle with CNCs adhered to a portion of its surface to achieve a higher DOH. FIG. 12(a) shows how the hydration process evolves, both inward and outward from the initial interface between cement and water (drawn with the dotted line) for a cement particle without CNC. FIG. 12(b) shows the same process with CNCs. For illustration and comparison purposes CNCs are placed only over a selected region of the cement surface. SCD is shown with an arrow indicating the extra hydration products growing inwards to the center of the cement particle. It is therefore expected that the inward growth in places without CNCs will have a slower rate than those in the CNC-rich regions. It is also likely that SCD may only be triggered by a critical concentration of CNCs in the hydration product shell.

Flexural Strength.

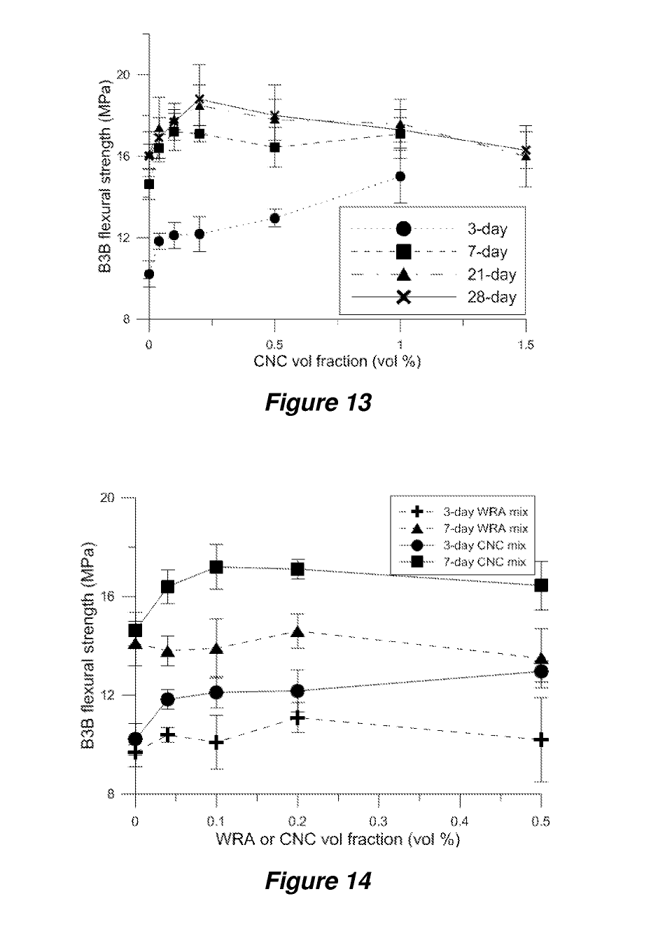

The flexural strengths of the cement pastes with increasing CNC concentrations were measured for 4 different ages (3, 7, 21 and 28 days) with the ball-on-three-ball tests (B3B); results are shown in FIG. 13. At the age of 3 days, the strength increases with increasing concentration of CNCs, while for older ages, the strength reaches a peak at around 0.2% of CNC and then decreases. This may be caused by agglomeration of CNCs at higher concentrations that act as stress concentrators (i.e., defects) in the cement. The agglomeration observed from the rheological measurements is consistent with that described here.

As the steric stabilization is also likely to improve the mechanical performance of cementitious materials, it is reasonable to compare the flexural strengths of the cement pastes with CNC and WRA. The B3B flexural strengths for the cement pastes with WRA were measured at the ages of 3 and 7 days and plotted against the values obtained for CNCs in FIG. 14. It should be mentioned that the comparison can only be done until 0.5 vol. % of CNC/WRA due to the strong segregation in the cement and water for higher concentrations of WRA. From FIG. 14, it is observed that there is a slight increase with increasing WRA concentration from 0% to 0.2 vol %. The DOH results show that the CNC are more effective in improving the strength than WRA. This is consistent with the increase in DOH shown in FIG. 11.

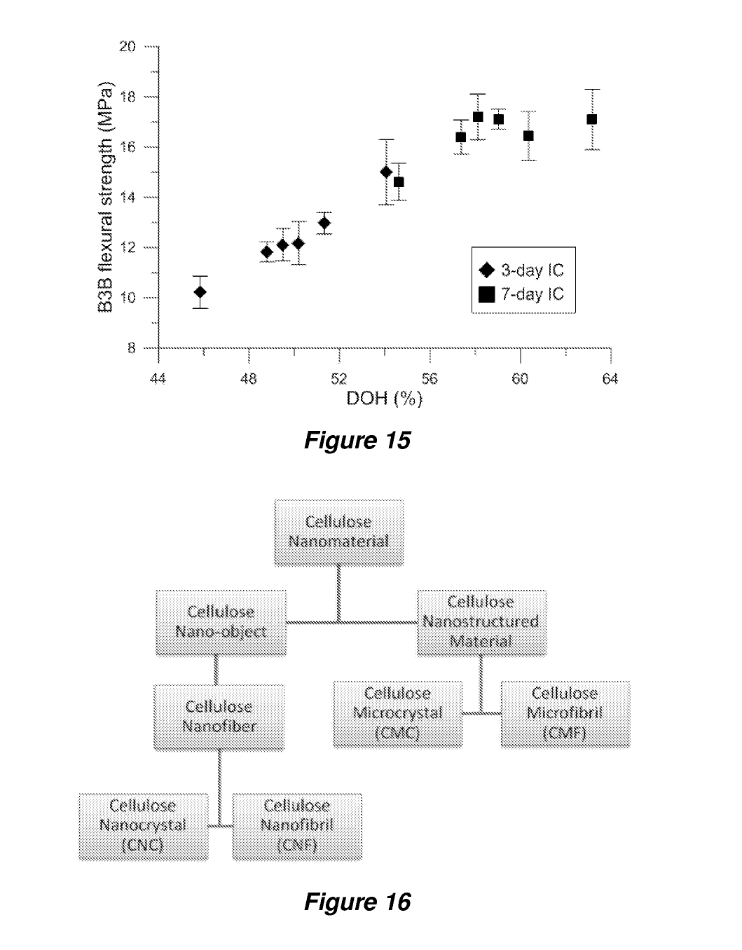

The main mechanism for strengthening can be directly attributed to the increase in DOH for high concentrations of CNCs. This can be analyzed by plotting the B3B flexural strengths against DOHs obtained from isothermal calorimetry. FIG. 15 shows the relationship between the B3B flexural strengths at the ages of 3 and 7 days with the DOH data from isothermal calorimetry (denoted as IC). The data in this plot is obtained from specimens with different CNC content (as obtained directly from FIG. 13). As can be observed, the B3B flexural strength increases nearly linearly as a function of DOH. This increase in strength is initially linear with respect to DOH until a DOH value of approximately 58%. The two points beyond 58% do not directly follow the linear trend. However, those points correspond to concentration of 1% and 1.5% of CNC for 7 days. As discussed above, and observed in FIG. 13, specimens with such high concentrations of CNCs begin to show signs of early failure, mainly caused by CNC agglomeration. Therefore, when a high flexural strength is desired, it may be advantageous to include less than 1.5 vol % of CNCs. However, when low viscosity and workability properties are desired, greater amounts of CNCs (e.g., 1-3 vol %, 1-5 vol %, or 1-10 vol %) may be advantageous.

Conclusions.

This examples describes how the addition of cellulose nanocrystals (CNCs) modify the performance of cement pastes. Flexural strengths of cement pastes with modest concentrations of CNC were about 20% to 30% higher than the cement paste without CNCs. This increase can be attributed to the increase in DOH of the cement pastes when CNCs are used. Based on experimental observations, two mechanisms explain the increase on DOH. (1) Steric stabilization is responsible for dispersing the cement particles. This mechanism is also exhibited by water reducing admixtures to improve workability. This dispersion effect is verified by rheological measurements for CNC-cement pastes, in which a decreased yield stress is observed with a low concentration of CNCs. (2) The CNC systems appear to exhibit a benefit due to short-circuit diffusion. Short circuit diffusion describes how the CNCs can provide a channel for water transporting through the hydration products ring (i.e., high density CSH) to the unhydrated cement particle and thereby improve hydration. The B3B flexural strengths increases with CNC concentration reach a peak at approximately 0.2 vol % of CNC. At higher concentrations of CNC the strength decreases, although workability is still improved. The decreased strength can be explained by the agglomeration of CNCs that acts as a stress concentrations in the cement paste. The 0.2% peak is also consistent with the rheological results that show that for higher CNC loadings the yield stress increases significantly due to the agglomeration.

### Example 2

### Dispersion of Cellulose Nanocrystal Addition and Strength Improvement of Cement Paste Via Short Circuit Diffusion

The agglomeration of the cellulose nanocrystals (CNCs) decreases the strength of cement pastes at high concentration. This example describes an approach to disperse the CNCs and examines the relationship between the dispersion and the mechanical performance of cement pastes. The critical concentration of CNCs in deionized water, above which a significant amount of agglomerations start prevailing, is studied with rheological measurements, which agree with the values obtained from an ellipsoidal percolation model. After introducing ions with a simulated cement paste pore solution, the critical concentration is found to be lowered by almost one order of magnitude, which appears to be related to the mechanical performance of the cement pastes, that above this concentration the strength starts decreasing.

To solve the agglomeration issue, tip ultrasonication was performed to effectively disperse the CNCs, and the degree of dispersion was characterized with rheological measurements. The cement pastes with ultrasonicated CNCs show much greater improvements in strength, of up to about 50%, and at the high concentration region no decrease in strength is observed. However, isothermal calorimetry results show that the cement pastes with ultrasonicated and non-ultrasonicated CNCs have very similar hydration processes as well as the degree of hydration.

A new centrifugation method was established to quantify the settled CNCs concentration on the cement surface. It was found that ultrasonication does not significantly decrease this concentration. This indicates that the ultrasonication does not disperse the CNCs into the pore solution but distributes them more uniformly on the cement surface, and hence the resulting degree of hydration is not changed significantly. Nanoindentation results support that the CNCs are highly concentrated around the interfacial region between high and low density calcium silicate hydrate (CSH) and the CNCs increase the reduced modulus at this region. The CNC-rich region was also verified, by EDX, that the oxygen content is much higher at the interfacial region for the cement pastes with CNCs, while in non-CNC pastes, the oxygen concentration did not show obvious fluctuation along different phases.

As discussed above in Example 1, cement pastes with cellulose nanocrystals (CNCs) show an improvement in the flexural strengths of at least 20% to 30% for different ages from 3 to 28 days. The increase in the degree of hydration (DOH) by CNCs is found to be responsible for the strength improvement. Two mechanisms were verified to explain the increase in DOH by CNCs: steric stabilization and short circuit diffusion (SCD), among which the latter plays a more important role. However, the strength improvement reaches a plateau at a CNC concentration of about 0.2% and then slowly decreases, due to CNC agglomeration. If the agglomeration issue is resolved, CNCs can improve the strength even further, especially at high concentrations (e.g., above ˜0.2%). This example is focuses on methods for reducing CNC agglomeration in cement pastes by ultrasonic dispersion and correlates the degree of dispersion with mechanical properties at the micro-level and the performance of cement pastes at the macro-level.

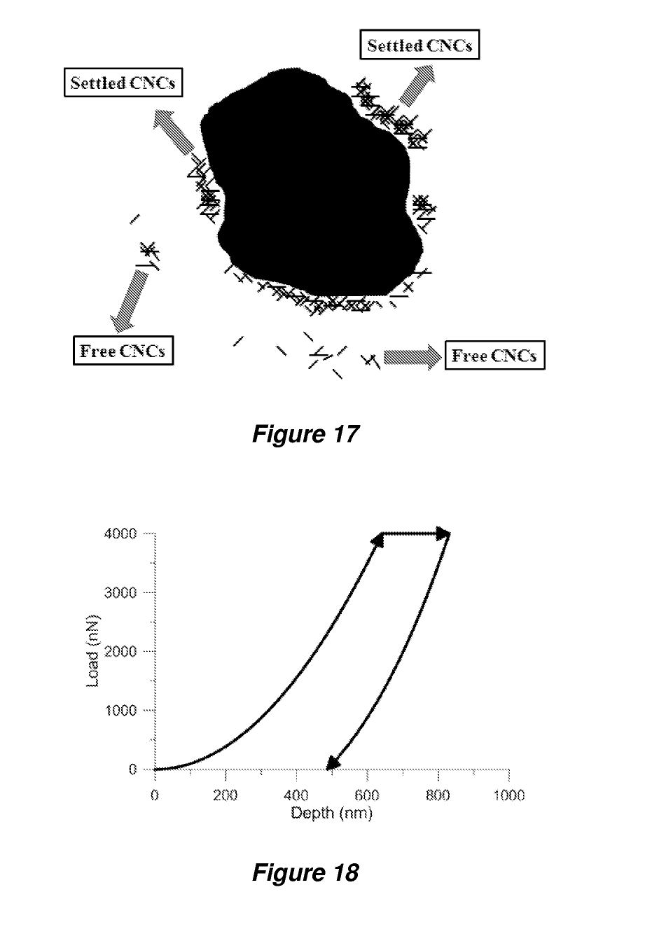

As the basic prerequisite for the mechanism of SCD is the adherence of CNC on the cement particles, acting as the pathway to transport water from the pores to the unhydrated cement core, the amount of the CNCs adhering on the cement particles is an important parameter. For simplicity, the CNCs in the fresh cement paste are distinctly categorized as two types: the “free” CNCs in the water and the “settled” CNCs adhering on the cement surface, as described in FIG. 17. While both types of CNCs are in water, the significant difference is that the settled CNCs are unmovable as they are bound with the cement particles and the free CNCs can move about in water as in an aqueous suspension.

The ability to distinguish and measure the amounts of the two different types of CNCs is important for three reasons: (1) SCD is contributed mostly by the settled CNCs; (2) because the mechanical properties (flexural strength) is compromised by the CNC agglomeration, dispersing settled CNCs is a straightforward solution; and (3) until now it was not clear role free CNCs play in the cement paste and whether they affect the microstructure of low density CSH and pores, and therefore the mechanical properties at the macro-level. In this example, an experimental approach is established to measure the concentrations of the two types of CNCs and relate them to the effect of SCD.

One key parameter related to agglomeration is the percolation threshold or critical concentration of the inclusions in the matrix phase. At this concentration, a significant amount of CNC agglomerations start prevailing in the matrix phase, and hence compromising the mechanical performance of the cement paste. As a result the determination of the critical concentration of CNCs is important in the study of the agglomerations in the cement matrix and how they affect the mechanical properties of the cement pastes. Garboczi et al. (Physical Review E. 1995; 52(1):10) established a percolation theory based only on the geometries of the inclusions in the matrix, regardless of their physical and chemical properties. This percolation theory is employed to calculate the critical concentration of CNCs in an inert matrix and is compared with the experimental data.

To disperse CNCs, there are two common methods: mechanical and chemical; ultrasonication has been found to be effective for breaking agglomeration. For other nano-scale fiber materials, such as carbon nanotubes, water reducing agents (WRA) can aid the dispersion with ultrasonication, and a polycarboxylate-based WRA is used herein to study CNC dispersion in water.

One link between the CNCs distribution in the cement paste and the mechanical performance at the macro-level is the CNCs influence in the micro-structural properties. Recently the development of the nanoindentation technique has made it possible to investigate the mechanical properties of cement composites at the micro- and nano-level. The nanoindentation technique has been successfully employed in the areas of interfacial transition zone in concrete, micro-mechanisms of creep in CSH phases, and statistical analysis of nano-mechanical properties governing ultra-high performance concrete microstructures. Because CNCs are completely disparate materials from cement, with different properties, they may alter the mechanical properties of the cement paste, e.g. elastic modulus and hardness, and these changes should be more obvious with higher concentrations of CNCs. For this reason, the micro-structural properties measured with nanoindentation can be indicative of the CNCs distribution in the cement pastes.

As verified in Example 1 above, a significant amount of CNCs are adhered on the cement particles in the fresh state, and a high concentration should be found in the high density CSH region. In this example, nanoindentation is performed at three different phases in hardened cement pastes: (1) the unhydrated cement particle, (2) high density CSH and (3) low density CSH, to study how the mechanical properties are influenced by CNCs. Mechanical properties of interest include the reduced indentation modulus Eᵣ, which is frequently used to characterize microstructural properties of cement composites.

A single load function was applied in this example with 4000 nN load-controlled mode. The three-segment load ramp is shown in FIG. 18: loading application with 5 s, hold time 5 s and unloading time 5 s. In this given indentation experiment, the peak load (Pₘₐₓ), the contact depth at the peak load (h), and the slope of the unloading curve (S=dP/dh) were obtained. The reduced indentation modulus Eᵣ can be determined by [8]

$${E}_{r} = \frac{d P}{d h} \frac{\sqrt{π}}{2 \sqrt{A}}$$

where A is the projected contact area, which need to be calculated from the indenter geometer and contact depth (h) based on previous calibration on the reference materials (Vandamme et al., Cement & Concrete Res. 2013; 52:15). dP/dh is the slope of unloading curve in the load-depth curve.

Materials and Experimental Testing.

A Type V cement was used in this example, as described in Example 1 above. Two different CNC materials were used in this work. One was manufactured and provided by the USDA Forest Service-Forest Products Laboratory, Madison, Wis., (FPL), as described above in Example 1 (5.38 wt. % CNCs in water). The CNCs were obtained at FPL by extraction of Eucalyptus dry-lap cellulose fibers via sulfuric acid hydrolysis, resulting in a 0.81 wt. % CNC surface-grafted sulfate content. The second form of CNC materials was a freeze dried powder, Na form, 0.96 wt. % sulfur on CNC.

This example analyzes the critical concentration or percolation threshold of CNCs in different matrices. The percolation threshold is based on the geometrical relationships between the inclusions and the matrix phase, and the concentration of CNCs for most cases is converted to the volume fraction of CNCs in the mixtures, i.e., CNC/(CNC+solvent) vol %. In certain sections below, such as the sample preparations, it is specified if the concentration is based on the weight fraction for convenience.

Ultrasonication.

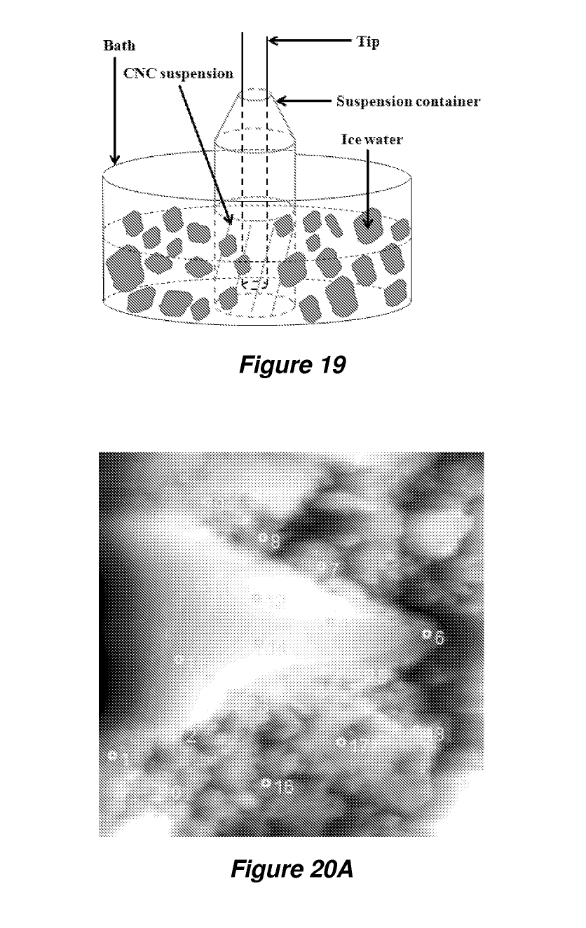

To disperse CNCs in an aqueous suspension, ultrasonication was performed with a Hielscher Ultrasonic Processor UP200S with a half inch tip. For the ultrasonication work, the amplitude was 25% and the cycle=0.5. During ultrasonication the temperature of the suspension was likely to increase due to the highly concentrated mechanical energy from the ultrasonic wave. This temperature increase might cause two affects: accelerated evaporation of the water and possible alteration of CNCs chemical structure. To avoid any possible influence a bath filled with ice water mixture was used to keep the temperature of the CNC suspension low, as shown in FIG. 19. The container for the CNC suspension chosen was cylinder-shaped with a small diameter, which was intended for a uniform dispersion in the radial direction. The container also has a small mouth, which is close to the diameter of the tip in order to reduce the water evaporation during the ultrasonication.

Cement Paste Preparation.

For cement pastes with different CNC materials (freeze dried or suspension), the CNCs were always introduced into the mixing container after cement, and the last step was to add extra water to keep the water to cement ratio at 0.35. The mixing procedures are described in Example 1. The mixtures proportions are listed in Table 2-1.

TABLE 2-1
Experimental matrix for pore solution (PS) suspensions
with CNCs (underlined).

| | | | | | | | | CNC/ |
|---|---|---|---|---|---|---|---|---|
| Mix- | | | | | | | CNC/ | suspen- |
| ture | wt (g) | | | vol (cm³) | | | cement | sion |
| ID | cement | water | CNC | cement | water | CNC | vol % | vol % |
| 1 | 500 | 175 | 0 | 160.3 | 175 | 0 | 0.00% | 0.00% |
| (ref) | | | | | | | | |
| 2 | 500 | 175 | 0.103 | 160.3 | 175 | 0.064 | 0.04% | 0.04% |
| 3 | 500 | 175 | 0.256 | 160.3 | 175 | 0.16 | 0.10% | 0.09% |
| 4 | 500 | 175 | 0.513 | 160.3 | 175 | 0.321 | 0.20% | 0.18% |
| 5 | 500 | 175 | 1.282 | 160.3 | 175 | 0.801 | 0.50% | 0.46% |
| 6 | 500 | 175 | 2.564 | 160.3 | 175 | 1.603 | 1.00% | 0.91% |
| 7 | 500 | 175 | 3.846 | 160.3 | 175 | 2.404 | 1.50% | 1.36% |

Centrifugation.

As introduced earlier, the CNCs in the fresh cement pastes can be categorized as the free CNCs and the settled CNCs. In this section, a centrifugation method is established to quantify the concentrations of the two different types of CNCs. At the age of 15 min, about 250 g fresh cement pastes are transferred into a Sorvall RC-3C Plus high capacity centrifuge. The centrifugation was performed at 5000 rpm for 20 min and the liquid on the top was collected. The collected liquid was then filtered thrice with filter paper to remove the cement particles until it is completely transparent without any observable solid particles. Previous control tests showed that most of the CNCs (>99.5%) passed through the filter paper, and therefore the change in the concentration due to the filtration is not taken into account. The filtered liquid was then weighed and dried in an oven at 50° C. for 48 hours. For the plain (non-CNC) cement paste, the final products after oven-drying are the salts and alkalis in the pore solutions, while for the cement paste with CNCs, the solids also contain the free CNCs. By comparing the solids concentrations obtained from the two different cement pastes, the concentrations for the free CNCs as well as the settled ones can be calculated.

Rheological Measurements.

Rheological measurements were taken to quantify the dispersion or agglomeration of CNCs in water and simulated pore solution. The rheological study was carried out on fresh cement pastes to relate the critical concentrations of CNCs in different matrices. The experimental details are described in Example 1 above.

Isothermal Calorimetry.

Isothermal calorimetry was taken to determine study how the dispersed CNCs affect the hydration process of the cement pastes and hence help to unravel to mechanism behind the improvement in the mechanical performance. The experimental details are described in Example 1 above.

Nanoindentation.

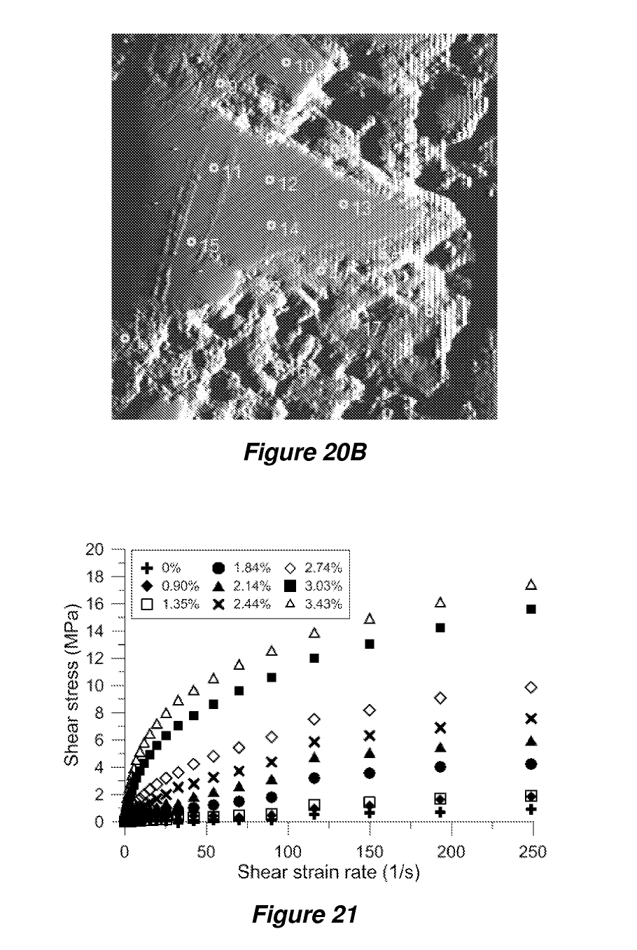

Three different cement pastes samples were prepared for the nanoindentation: plain (reference), with 1.5% non-ultrasonicated CNCs, and with 1.5% ultrasonicated CNCs, all of which were sealed at 23° C. after cast. At the age of 28 days they were cut with a low-speed oil saw to expose a fresh surface. A lapping procedure at 45, 30, 15 μm with paraffin oil for 12 minutes each and a polishing procedure using 9, 6, 3, 1, 0.25 μm diamond paste for 20 minutes each on top of Texmet paper were conducted on the sample surface. The nanoindentation was performed on the three different phases: unhydrated cement particles, high density CSH, and low density CSH, with a TI 950 TriboIndenter from Hysitron Corporation. FIG. 20 shows an example of a 50 μm×50 μm surface inspected, among which, (a) is the topographic image and (b) the gradient image. The dots with numbers show the indentation locations chosen. In this case, indentations 1˜9 are for the interfacial region, 10˜15 are for the unhydrated cement particle, and 16˜18 are for the matrix (low density CSH). The distance between any nearest two nanoindentations are at least ˜10 μm to avoid influence from each other. For all the indentations, the load cycles are the same, as shown in FIG. 18, the maximum load is 4000 μN, and the holding time between loading and unloading is 5 sec.

The B3B flexural and SEM tests and analytical procedures are described above in Example 1.

Energy Dispersive X-Ray Spectroscopy (EDX).

EDX was performed on the plain cement paste and the with 1.5% non-ultrasonicated CNC paste with a FEI Quanta 3D FEG equipment to investigate the CNC distribution. The data were plotted as normalized signal counts of oxygen with the physical position along the scanning line. Because the CNCs cannot penetrate the unhydrated cement cores, the chemical compositions as well as the oxygen concentration should be the same for the reference and the 1.5% samples. With a normalization with the oxygen concentration within the unhydrated cement cores, the signals can be compared between the EDX results for the two samples without taking into account the experimental conditions. The normalization of the signal counts was done with following procedures:

(1) The signals collected within the unhydrated cement cores for both the reference and the 1.5% samples were chosen and the average count in this region was calculated as N_{ave-ref} and N_{ave-1.5%}.

(2) All signals along the scanning line were divided by N_{ave-ref} and N_{ave-1.5%} for the two samples respectively and plotted with the scanning position.

### Results and Discussion

The Agglomeration of CNCs.

As discussed above, the distribution of the CNCs in the cement matrix is crucial with respect to not only the micro-structures modification, but also the mechanical performance at the macro-level. This section discusses the percolation threshold or critical concentration of CNCs in an inert environment and the cement pore solution via a combined approach of theoretical and experimental analysis and its relevance to the mechanical performance of the hardened cement pastes. Garboczi et al. (Physical Review E. 1995; 52(1):10) developed a theoretical model for percolation based only on the geometry of the inclusions, according to which, the percolation threshold is dependent only on the aspect ratio of the inclusion and can be determined by the following Pade-type formula:

$$P ( x ) = \frac{h + fx + {gx}^{3 / 2} + {cx}^{2} + {dx}^{3}}{sx + {x}^{2}}$$

in which x is the aspect ratio, and all the other coefficients are as provided by Garboczi. This model can be employed to estimate the critical concentration of the CNCs in an inert environment such deionized (DI) water without influential factors such as electrostatic force. Moon et al. (Chem Soc Rev. 2011; 40:54) provide a dimension range for typical CNCs as 3-5 nm wide and 50-500 nm in length. In the same paper, a TEM image (FIG. 9(e) from Moon et al.) shows that a majority of the wood CNCs have the lengths around 200 nm. For simplicity, in this work, the aspect ratio of the CNC is estimated as 50 and the resulting percolation threshold is calculated as 1.38% with the above Pade-type formula.

When the inclusion concentration in the matrix reaches the critical concentration, some of the composites materials properties are subject to significant changes. Rheological measurements were carried out as an experimental approach to investigate the percolation threshold of CNCs in DI water, cement pore solution and the fresh cement pastes. FIG. 21 shows the relationships between the shear stress and the shear strain rate for CNC-DI water suspensions with concentration from 0 to 3.43%. From these results it can be observed that with increasing the CNC concentrations, the viscosity increases at all ranges of the shear strain rate. This is because the concentrated CNCs form network or agglomerations in the water matrix, which need to be broken or aligned during the rheological measurements, and result in higher stress.

The stress-rate relationship of the CNC aqueous suspensions shows a shear thinning behavior when the shear rate is increased, especially for the high concentration suspensions. The behavior is typically described in the Herschel-Bulkley model, which gives the relationship between the shear stress and rate as:

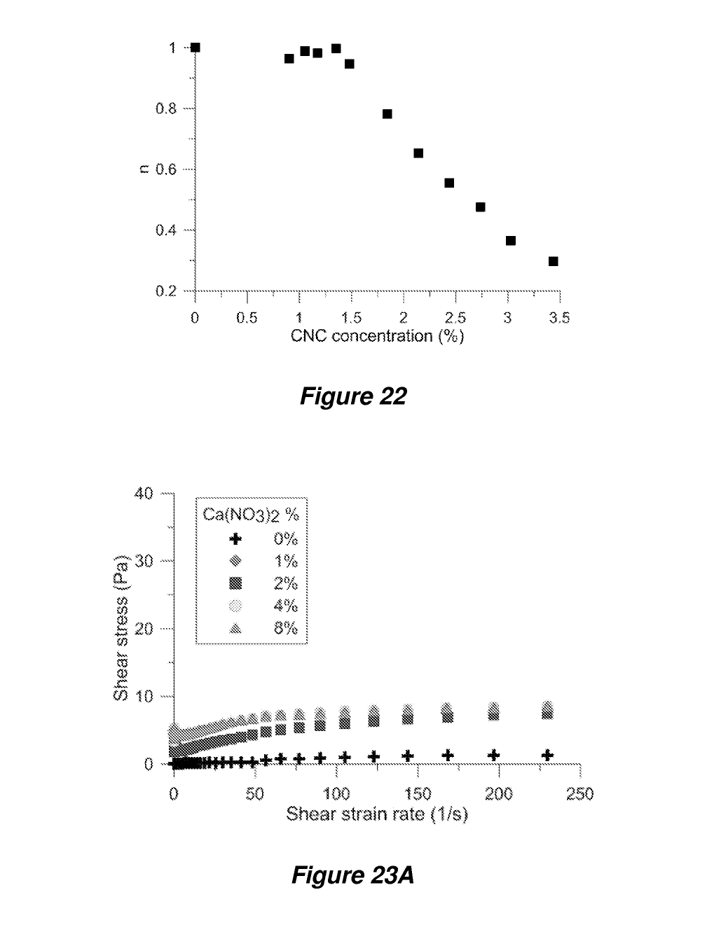

τ=τ₀+Kγⁿ

where τ is the shear stress, τ₀ the yield stress, γ the shear rate, K and n the model factors. The factor n is directly related with the shear thinning or thickening behavior which happens for the non-Newtonian fluid: if n>1, the fluid is shear thickening, while when n<1 the fluid is shear thinning. All the stress-strain curves of the CNC suspensions with concentration from 0 to 3.43% are fitted with the Herschel-Bulkley equation and the factor n is plotted with the CNC concentrations as shown in FIG. 22 (in total 12 concentrations were measured, only 9 of which are shown in FIG. 22 for succinctness). The first data point with 0% of CNC is pure water, which is a typical Newtonian fluid and the n is designated as 1. All other data are from the fitting of the Herschel-Bulkley equation.

The relationship between n and CNC concentration shows an interesting trend that n is kept at a plateau of 1 until about 1.35% and then drops with a linear-like relationship. This seems to indicate that a threshold around 1.35% exists between the Newtonian and non-Newtonian behavior. Above 1.35%, the factor n is consistently decreasing with increasing CNC concentration, which means a stronger shear thinning due to the alignment or orientation of CNCs at a high shear rate and the suspension is more fluid. For low concentration suspensions and water (Newtonian), shear thinning is not evident because the CNCs do not percolate in the matrix or form a significant amount of agglomerations or network that need substantial force to break or align them. To conclude, n is strongly related with concentration and can be an indication of when percolation happens. Based on the rheological measurements on the CNC DI water suspensions with different concentrations, the percolation threshold is around 1.35%, which agrees very well with the theoretical value 1.38% calculated from the geometrical percolation theory.

As verified that the CNCs in water can have significant agglomeration with strong interactions after reaching a percolation threshold of around 1.35%, the situation is not necessarily the same when the CNCs suspensions are mixed with cement. When water is mixed with cement, the solvent is no longer pure water, instead it is the cement paste pore solution, in which ion species such as K⁺, Na⁺, Ca⁺², OH⁻, SO⁴⁻ exist. These ions are likely to cause the surface charges on the CNCs to alter their agglomeration or dispersion state, and hence an evident change in their rheological properties as well as the percolation threshold. To investigate how the ions affect the interactions between CNCs with the surface charges, Ca(NO₃)₂ was introduced into the CNC suspensions with varying concentrations.

Two different CNC suspensions were prepared with the concentrations of 1.23% and 2.44%, in which the former concentration is slightly lower than the percolation threshold 1.35%, while the latter is above that. The experimental design is shown in Table 2-2.

TABLE 2-2
Experimental design of surface charged CNC solutions.

| | Group 1 | | | | | Group 2 | | | |
|---|---|---|---|---|---|---|---|---|---|
| | CNC | | | | | CNC | | | |
| | conc. = 1.23% | | | | | conc. = 2.44% | | | |
| ID | 1 | 2 | 3 | 4 | 5 | 6 | 7 | 8 | 9 |
| Ca(NO₃)₂ concentration | 0% | 1% | 2% | 4% | 8% | 0% | 2% | 4% | 8% |

After adding Ca(NO₃)₂ into the CNC suspensions, all suspensions gel immediately and the materials are no longer transparent. The reference samples (#1 and #7) are relatively transparent, while all the samples with calcium nitrate become opaque. Suspensions #8, #9 and #10 are extremely viscous and they tend to adhere to the wall of the containers after mixing.

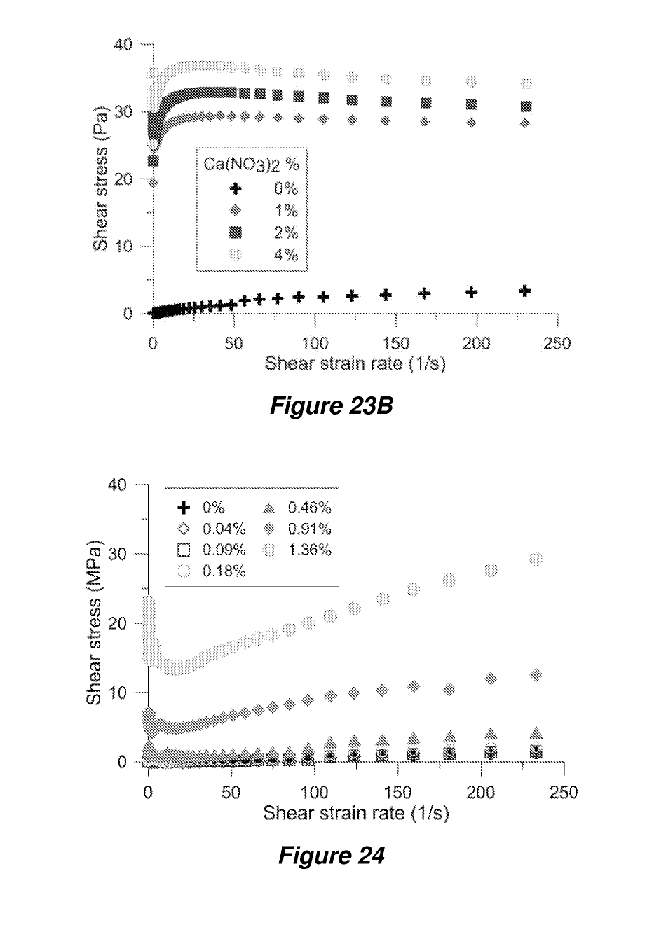

Rheological measurements were taken for all suspensions and the relationships between the shear stress and shear strain rate are shown in FIG. 23. From the results it is concluded that: (1) the yield stresses are increased significantly with the Ca(NO₃)₂ concentration; (2) the viscosities are also increased at within all range of shear strain rate; and (3) for FIG. 23 (b), the trends are very interesting in that when the three mixtures with Ca(NO₃)₂ reach their peaks at about 25 1/s, the shear stresses decrease above this value. This feature is not common for simple fluids and it may be because at high shear strain rate, the parallel plate breaks the surface charge-induced agglomerations and a reduction in agglomeration results in a decrease in shear stress. This feature is only observed in FIG. 23 (b) because the CNC concentration for Group 2 is much higher than the percolation threshold, while for Group 1 it is below the threshold. In sum, the surface charges change the rheological behavior significantly (yield stress and viscosity), by making the CNCs adhere to each other and form an agglomeration/network, which are harder to break compared with the suspensions without surface charges.

As the charged system with Ca(NO₃)₂ shows significant difference in the rheological properties compared to the pure CNC suspensions, the influence of the multiple-ion species in the cement pore solution may be even more complicated. A simulated pore solution with different ions was prepared based on the data of the 1-hour cement paste pore solution by Rajabipour et al. (Cement & Concrete Res. 2008; 38(5): 10). The concentrations of the different ions are shown in Table 2-3.

TABLE 2-3
Ions concentration in pore solution at 1 hour.

| ions | Conc. (mol/L) | Charge (mol/L) |
|---|---|---|
| K⁺ | 0.43 | 0.57 |
| Na⁺ | 0.1 | |
| Ca²⁺ | 0.02 | |
| OH⁻ | 0.17 | 0.57 |
| (SO₄)²⁻ | 0.2 | |

The solution prepared according to Table 2-2 was then diluted with DI water by 4 times to reach a pH that is close to the pH of the fresh cement paste used in this work, which was measured as 12.71 as listed in Table 2-4.

TABLE 2-4
The pH values for the fresh cement paste and the simulated
pore solutions before and after dilutions.

| | | pH | |
|---|---|---|---|
| | OH⁻ | theoretical | |
| | (mol/L) | value | measurement |
| Pore solution from Table 2-2 | 0.17 | 13.23 | 13.25 |
| Diluted 4 times | 0.043 | 12.63 | 12.70 |
| Fresh cement paste | / | / | 12.71 |

The CNC pore solution suspensions were prepared according to the 7 mixtures prepared for the B3B flexural test, which can be regarded as the mixture of the “fresh cement paste with the cement taken out”. The concentrations are shown in Table 2-1, underlined.

The relationships between the shear stress and shear strain rate are shown in FIG. 24. Compared with the results for DI water CNC suspensions (FIG. 21), two features can be observed. (1) The viscosity is increased at the same shear rate. In other words, with much smaller concentration of CNCs than in the aqueous solution, the same amount of agglomeration happens in the pore solution. (2) There is a much larger yield stress for pore solution with high concentrations of CNCs, while for the aqueous solutions the yield stress changes little with CNCs.

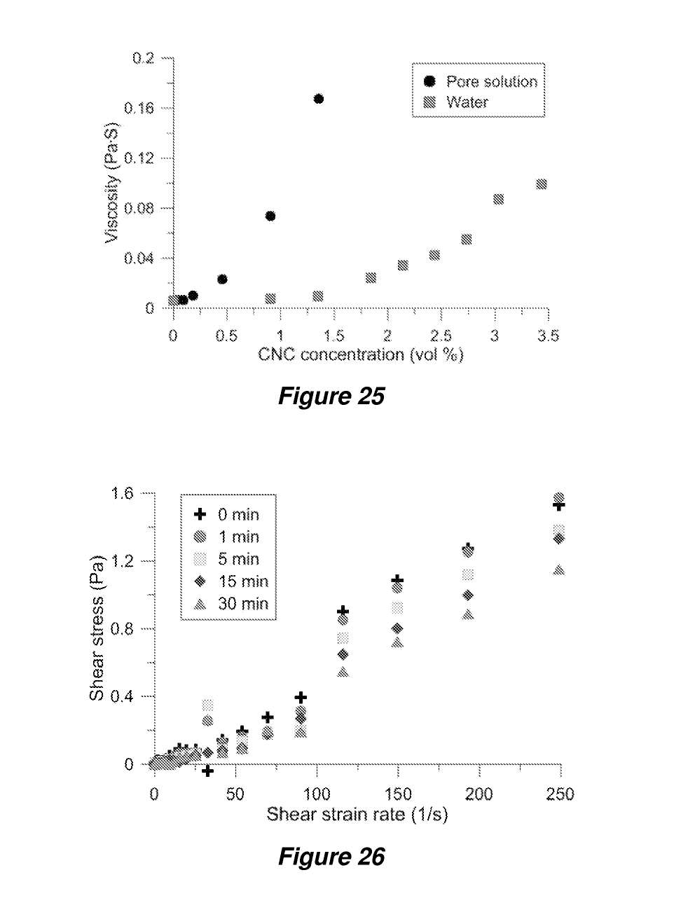

The viscosities at about 140 1/s were calculated for aqueous CNC and pore solution CNC and are plotted in FIG. 25. It can be clearly observed that with the same CNC concentrations in the fluids, pore solution with the surface charges on the CNCs surface is much more viscous than the aqueous suspension.

These differences indicate that the surface charges result in agglomerations of CNCs which increase both the viscosity and the yield stress of the mixture. It is noteworthy from FIG. 24 that when the CNCs are increased from 0% to 0.18%, there is no obvious change in the stress-strain rate relationship. A jump in the shear stress happens when the concentration is increased from 0.18% to 0.46%, where both the viscosity and the yield stress are increased significantly. This is likely due to the agglomerations beginning to prevail in the suspensions at the concentrations around 0.18%. From Table 2-1, the CNC concentration of 0.18% is corresponding to the CNC/cement concentration of 0.2% where the peak strengths were obtained for the CNC cement pastes.

To conclude, the rheologically critical concentration of CNCs in the pore solution is consistent with the peak strength achieved for the cement pastes, at which concentration there might be a considerable amount of CNCs agglomerations start forming. As a summary, the different critical concentrations for CNCs agglomeration are listed in Table 2-5. It was found from the rheological measurements that the percolation threshold is about 1.35%, which is basically consistent with the theoretical value 1.38% calculated from the geometrical percolation theory. This percolation threshold, however, does not necessarily apply for the CNCs in the cement pastes, as the solvent is no longer pure water; instead the pore solution contains different ions species. Rheological studies of CNCs in Ca(NO₃)₂ and simulated pore solutions show that surface charges from the ions severely induce the agglomeration of CNCs and the critical concentration is decreased. From the shear stress-strain curves, there is an obvious increase in viscosity from 0.18% to 0.46%, which correlates to the cement pastes 0.2% to 0.5%. Meanwhile it was already found that the strength peaks at the volume fraction of 0.2% and then drops, and also the yield stress starts increasing significantly above 0.2%. Thus, the surface charges from the pore solution decreases the percolation threshold of CNCs from about 1.35% to around 0.18%, and therefore decrease the strength above this concentration.

TABLE 2-5
Critical CNC concentrations obtained from different sources.

| | | CNC/cement | CNC/(CNC + solvent) |
|---|---|---|---|
| Matrix | Data source | (vol) | (vol) |
| Inert | Theoretical | / | 1.38% |
| | DI Water matrix | / | 1.35% |
| Charged | Pore solution matrix | / | 0.18%~0.46% |
| | Yield stress of | 0.2%~0.5% | 0.18%~0.46% |
| | fresh cement paste | | |
| | Peak strength of | 0.20% | 0.18% |
| | hardened cement pastes | | |

Dispersion of CNC.

The agglomeration of CNCs in the cement paste is detrimental with respect to the mechanical performance as they may act as stress concentrators when a load is applied. To disperse the CNC agglomerations and make them more uniformly distributed in the cement paste is the most straightforward way to remove the stress concentration and improve the mechanical properties. Tip ultrasonication is performed for the CNC aqueous suspensions with the procedures described earlier. The resulting suspensions for the three different ultrasonication durations: 0, 5 and 30 minutes show different degrees of transparency. It was observed that the transparency increases with longer ultrasonication duration, which indicates that agglomerations are broken into single CNCs.

To quantitatively evaluate the degree of dispersion with ultrasonication, rheological measurements were taken for 1.35% CNC suspensions with increasing ultrasonication durations: 0, 1, 5, 15 and 30 minutes; results are shown in FIG. 26. The CNC materials used here are freeze dried (as described above), while the rheological results above this section are all from the suspension CNCs, and the data should not be directly quantitatively compared between different batches (freeze dried and suspension). From the results, there is a clear trend that the overall shear stress decreases with increasing ultrasonication duration, which is indicative of the dispersion of CNCs agglomerations in the suspension.

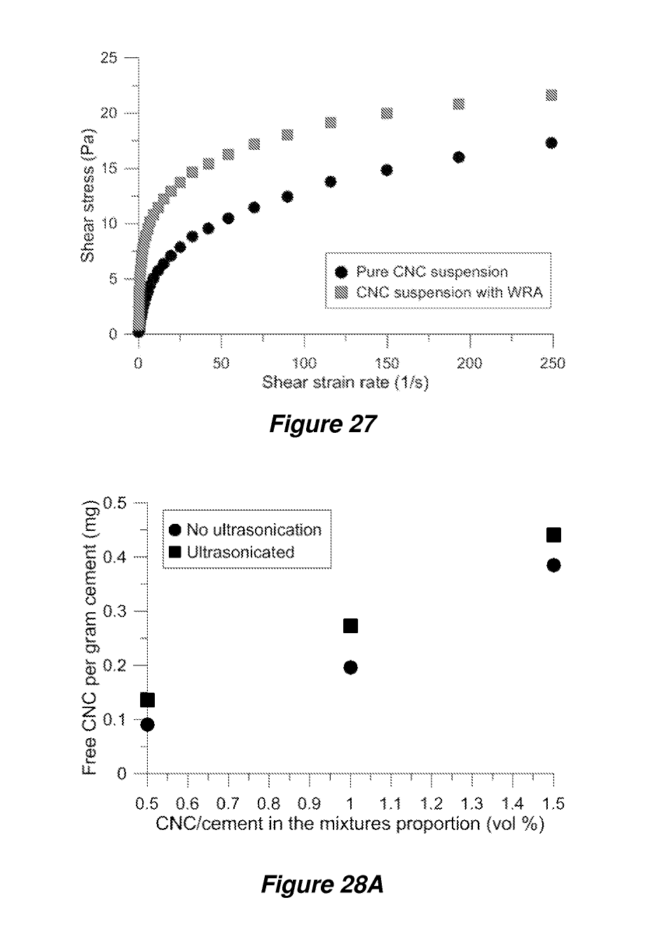

To help facilitate the CNCs dispersion in the aqueous suspensions, a polycarboxylate-based WRA ADVA 140 was added in the suspensions with three different WRA/CNC weight ratios: 0.5, 1 and 3. The transparencies were observed after different ultrasonication time. It is noteworthy that with WRA, the suspension is less transparent at all ultrasonication times, which is because the WRA itself is less transparent than the CNCs suspension. Another possible reason is the interaction between WRA and the CNCs making CNCs gel to some extent. The rheological behavior was evaluated for the pure CNC suspension and one with WRA (WRA/CNC=0.5), and the stress-rate relationship is shown in FIG. 27.

The shear stress as well as the viscosity increased after the WRA was added, which means there are interactions between the WRA and CNCs. It is noteworthy that the ADVA 140 was chosen among 6 different commercial WRAs because based on preliminary results, it is most compatible with the CNCs, while the other 5 WRAs increase the viscosities of CNC suspensions much higher than the ADVA 140. The cement pastes with the ultrasonicated CNCs with different amount of WRA were tested by the B3B flexural test to evaluate the dispersion effects of the WRA and ultrasonication; the results are reported further below.

Short Circuit Diffusion.

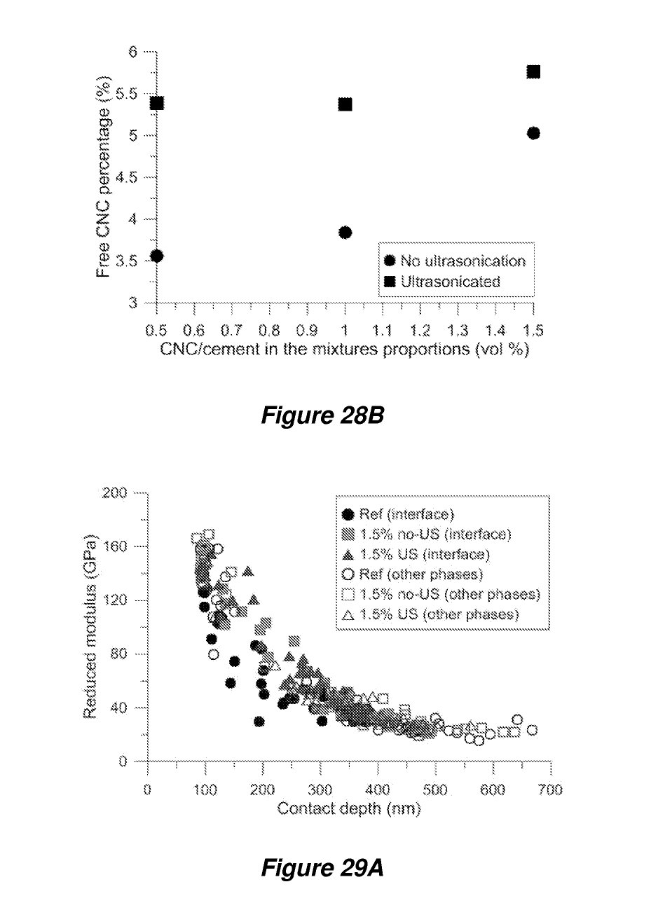

Measurement of CNCs on cement surface. As discussed in Example 1, the basic prerequisite for SCD is certain amount of CNCs are adhered on the cement particles surface. This mechanism has been investigated by isothermal calorimetry, zeta potential measurements, optical and scanning electron microscopy. In this example, the amount of CNCs adhered on the cement particles are quantified by the centrifugation method with the procedures described above. In total there were three different concentrations studied: 0.5%, 1.0% and 1.5%, with and without 30-min ultrasonication. FIG. 28(a) shows the mass of the free CNCs per gram of cement, and (b) gives the free CNC percentages out of all CNCs, i.e., free CNCs/(free+settled CNCs) %.

The results in FIG. 28(a) indicate that with increasing the loaded CNC (from 0.5% to 1.5%) the free CNC per gram of cement is increasing and after ultrasonication the amount of free CNCs is slightly increased for all the three concentrations. FIG. 28(b) shows that the percentage of the free CNCs out of all is not increased significantly −3.5% to 5% for the non-ultrasonicated CNCs and 5.4% to 5.8% for the ultrasonicated samples. In other words, most of the CNCs (94.2% to 96.5%), are still the settled ones adhered on the cement particles, even after ultrasonication. This result indicates that the cement particles keep adsorbing the CNCs on their surface with increasing the CNCs loading without reaching any saturation point. A simple calculation is given here to estimate the maximum surface area of cement particles that can be covered by CNCs with a simple assumption that all the CNCs are lying on the surface and there is no overlapping between each other. Given that the cross-section of the CNC is 4×4 nm² square, the maximum area covered with CNCs for every kg cement for the cement pastes at three highest conc. 0.5%, 1.0% and 1.5% are listed in Table 2-7.

TABLE 2-7
Maximum area that can be covered with CNCs for the 7 mixtures.

| Mixture (CNC/cement vol.) | 0.5% | 1.0% | 1.5% |
|---|---|---|---|
| Max. surface covered by CNCs (m²/kg) | 400 | 800 | 1200 |

As the Blaine fineness of the cement used in this work is 316 m²/kg, CNCs can ideally cover all the surface area of cement for the three highest concentrations. However, this calculation does not account for the free CNCs as well as the overlapping of the settled CNCs on the cement surface, which is very likely considering the agglomeration. For these reasons, the actual area covered by CNCs should be smaller than the values calculated above and the adsorption might be far from saturation, which determines the concentration of CNCs stop adhering onto the cement surface.

Nanoindentation.

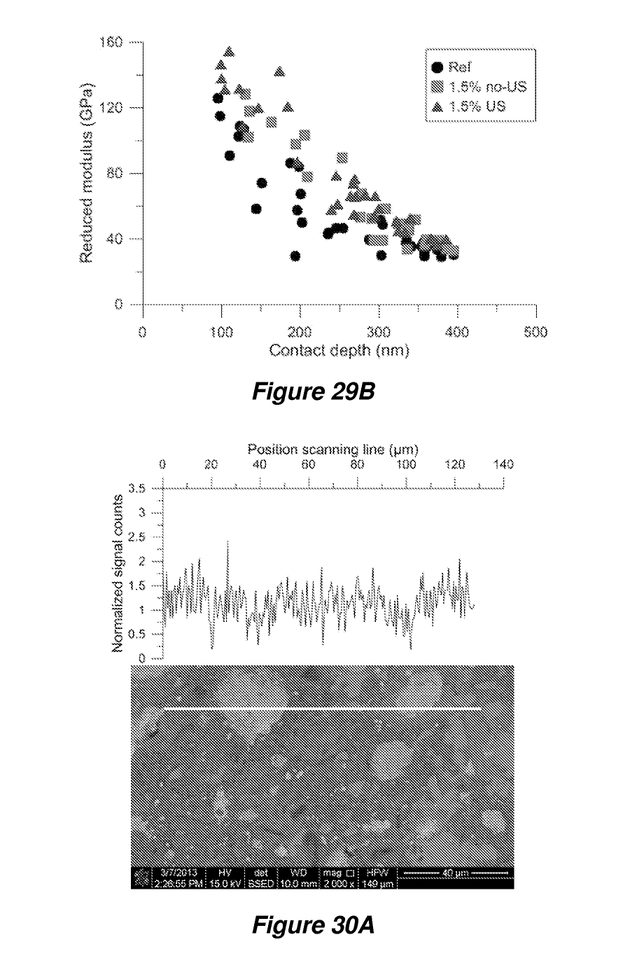

Nanoindentation is performed to study the CNCs distribution in the hardened cement pastes and their influences on the microstructural mechanical properties. Three different samples are inspected: the cement paste without CNCs, cement paste with 1.5% ultrasonicated CNCs, and samples with 1.5% non-ultrasonicated CNCs, denoted as Ref, 1.5% US, and 1.5% no-US. The locations chosen for the nanoindenation are from three difference phases: the low density CSH (matrix phase), the unhydrated cement particle, and the high density CSH (the interface between the particle and the matrix). As a majority of CNCs locate at the interfacial region, this is the phase of the most interest. The reduced modulus was plotted with the contact depth as shown in FIG. 29, among which, (a) gives the reduced moduli for all the three different phases, while (b) only shows the data obtained from the interfacial regions. In the plots the data on the interfacial regions are designated as the solid symbols and the data from the other two phases (unhydrated cement and matrix) are open symbols.

From FIG. 29 it can be observed that for the three different samples, the reduced modulus is more or less overlapping at the cement particle and matrix phase, while for the interface, the reference sample has generally lower modulus than the other two samples. This is likely due to the high elastic modulus of CNCs, which ranges from 110 to 220 GPa, which is significantly higher than that of the interfacial region with the value about 40-110 GPa. For simplicity, if the mechanical properties of the “composites” constituted by the interface and the CNCs follow a mixtures law, the modulus can be significantly improved by CNCs with respect to the interface without CNCs. The other possible explanation for the higher modulus at the interface is the interaction between the CNCs and the CSH makes the micro-structure denser.

EDX.

EDX technique has been widely employed for elemental analysis of the chemical compositions of cement composites (Famy et al., Cement & Concrete Res. 2003; 33:10). In this example, the EDX was performed to investigate the CNCs distribution in the hardened cement pastes. The two specimens studied were the reference and the one with 1.5% non-ultrasonicated CNCs. Ideally the element carbon should help to locate the CNCs in the cement pastes because cement does not contain a significant amount of carbon while CNCs do. However, based on the preliminary EDX results, carbon was detected all over the surface on the specimen of the cement paste, which was likely due to the carbonation.

Carbon spectroscopy does not show significant difference between the specimen with and without CNCs. It is noteworthy that all the specimens for EDX were carefully stored in the desiccator in order to reduce the influence from carbonation. Obviously the hardened cement paste samples are prone to carbonation and the element carbon cannot be used as the criterion to characterize the CNCs distribution. For this reason, this example focuses on oxygen spectroscopy and studies how the oxygen concentration fluctuates at different phases in the cement paste.

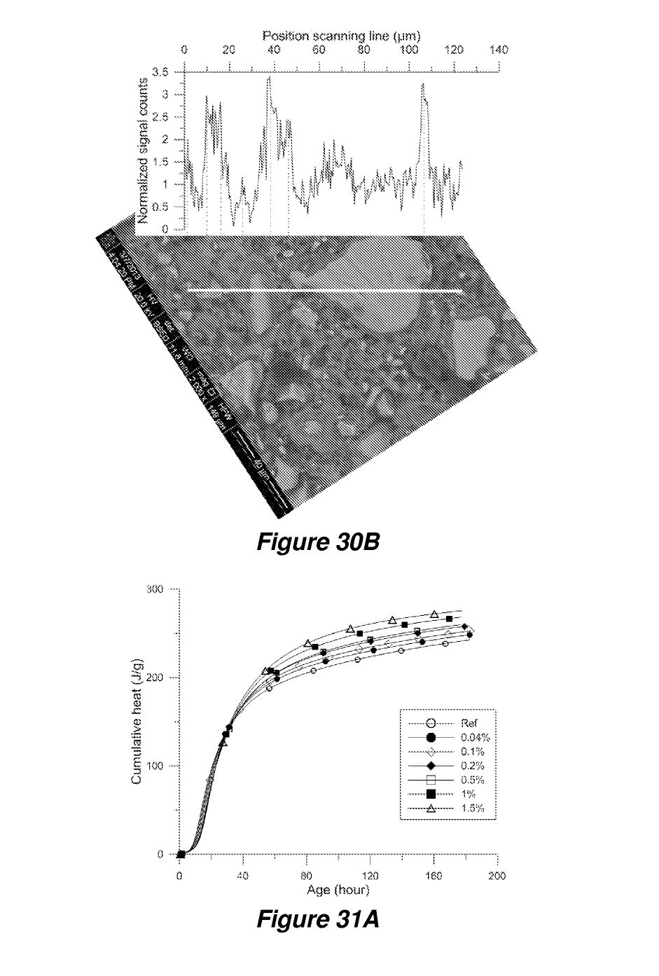

In order to compare the data between the two samples, a normalization was done for the signal counts according to the procedures described in the EDX section above. The results for the oxygen spectroscopy are shown in FIG. 30, from which it can be observed that for the reference sample, the oxygen concentration is relatively stable, while for the cement paste with 1.5% CNCs, several sharp peaks are observed. The peaks are highlighted with the dash lines to denote their corresponding locations on the cement paste surface and it can be observed that most of the peaks are obtained at interfacial regions between the unhydrated cement and the matrix. As CNCs are a significant source of oxygen (C₆H₁₀O₅), the peaks of oxygen are most likely from the CNCs, which is consistent with the SCD theory that a high concentration of CNCs adhered on the surface of the cement particles and form a path for the transportation of water.

Isothermal Calorimetry.

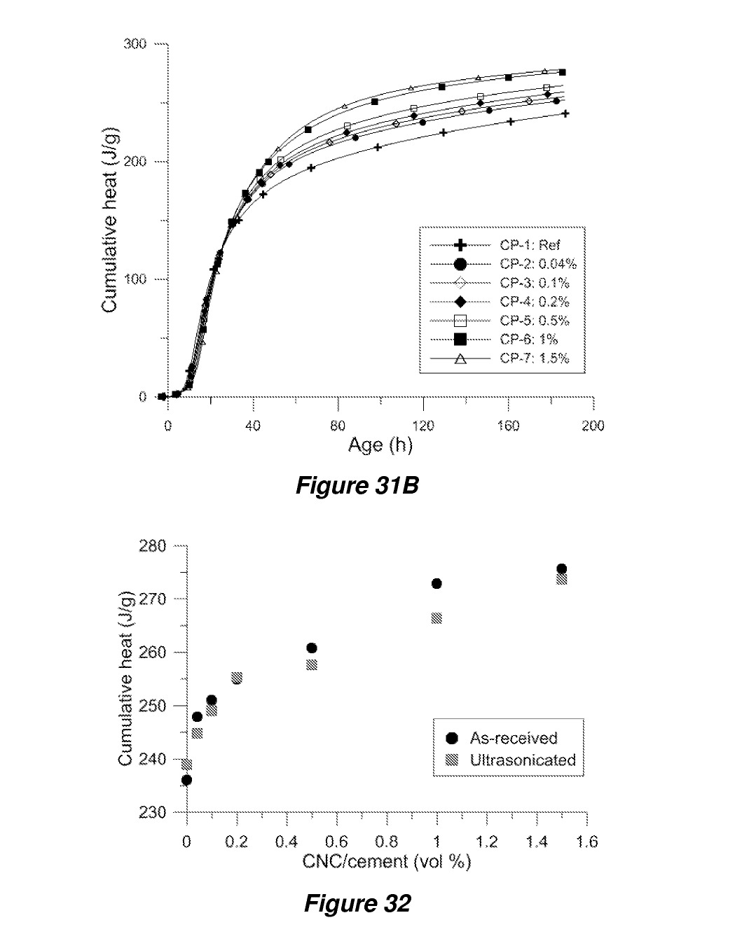

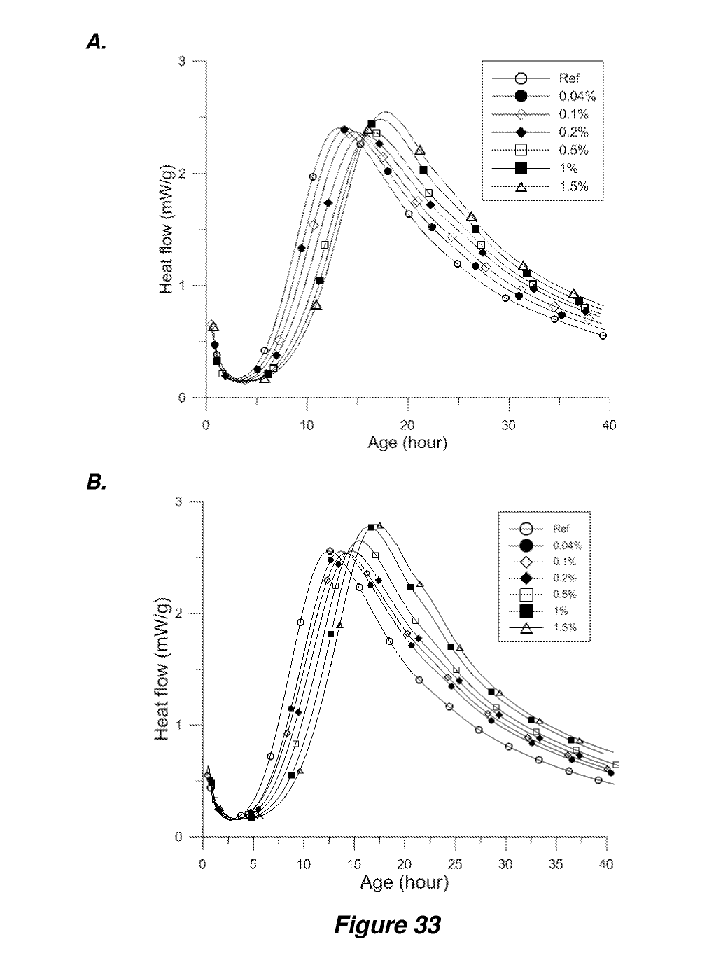

To study the influence of the ultrasonication on the CNC-cement interactions, the cumulative heat of the cement pastes with non-ultrasonicated and ultrasonicated CNCs for the first 200 hours were measured with IC; the results are plotted in FIG. 31. The general trends are very similar between the two different systems. The cumulative heats at the age of 7 days are summarized in FIG. 32 and the values are generally very close at all concentrations. The heat flow rate curves are also very similar between the cement pastes with the two different CNCs as shown in FIG. 33. Thus, whether the CNCs are ultrasonicated or not, not only are the cumulative heats at the age of 7 days very close, the hydration processes are also more or less the same, which implicates that the ultrasonication does not significantly influence the hydration.

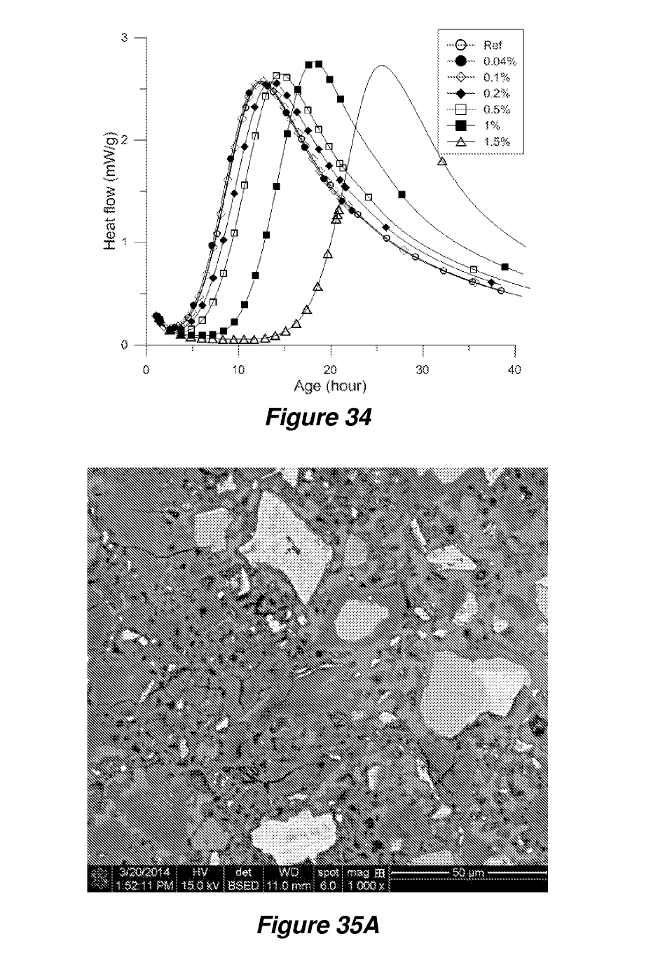

As the polycarboxylate-based WRA is similar with CNCs with respect to the adsorption on the cement particles and both can sterically stabilize the cement particles, a parallel hydration study was performed on cement pastes with varying dosages of the WRA ADVA 140. As expected, with WRA, the dormant period is extended significantly, as shown in FIG. 34, and that the heat flow peak delay for the 1.5% WRA cement paste is about 15 hours, which is much longer than that of the 1.5% CNC cement paste (˜5 hours). This means the effect of steric stabilization from the WRA is more evident than that from the CNCs, which is likely due to the hydrophilic surface of CNCs. As a consequence, while the CNCs sterically block water from reacting with cement, they are also transporting it. Among the two opposite effects, the former causes a delay in the hydration process at the early age, and the latter increases the DOH at later ages.

SEM.

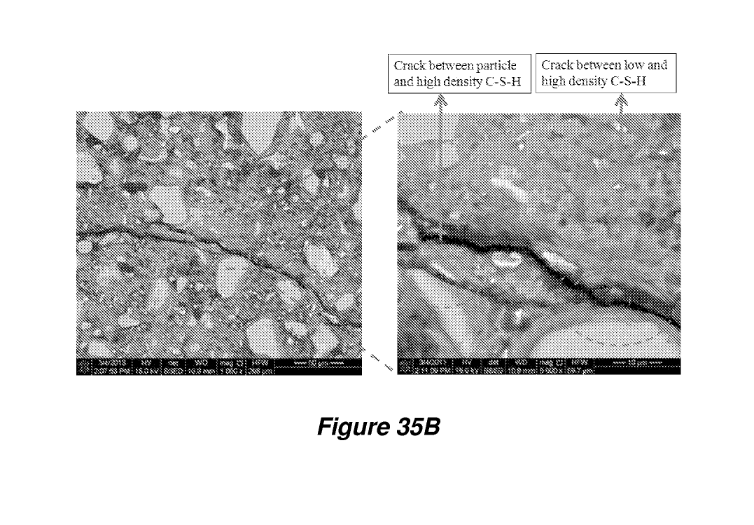

As observed in Example 1 above, cement pastes with CNCs show the “ring” features around the unhydrated cement particles, which are believed the CNC-rich regions. In this example, the relevance of the CNC-rich region to the microstructural mechanical properties is explored. From the SEM images shown in FIG. 35, multiple cracks are observed for both the cement pastes with and without CNCs. It is interesting that the cracks in FIG. 35(b) pass through two difference interfaces, one between the cement particle and the high density CSH, and the other between low and high density CSH, as circled in FIG. 35(b).

In the nanoindentation section above, it was found that the CNCs can improve elastic modulus of the interfacial region between and high and low CSH. It was also verified that the strength improvement of the cement paste with CNCs is a result of the DOH increase by SCD. It is thus likely that the porosity reduction is more important in improving the strength than the interactions between and CNCs and the CSH.

Flexural Strength.

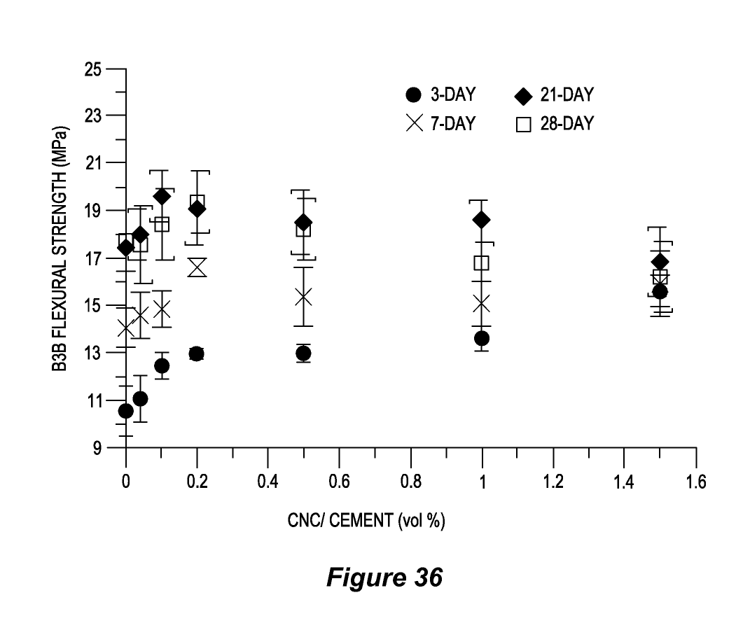

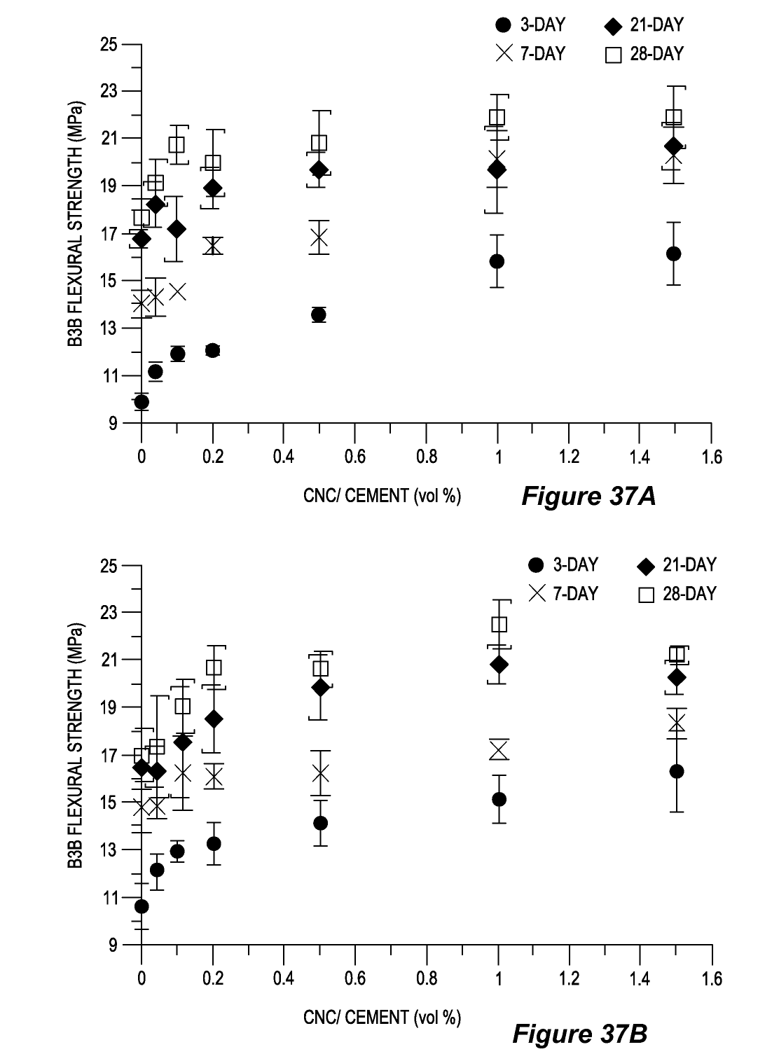

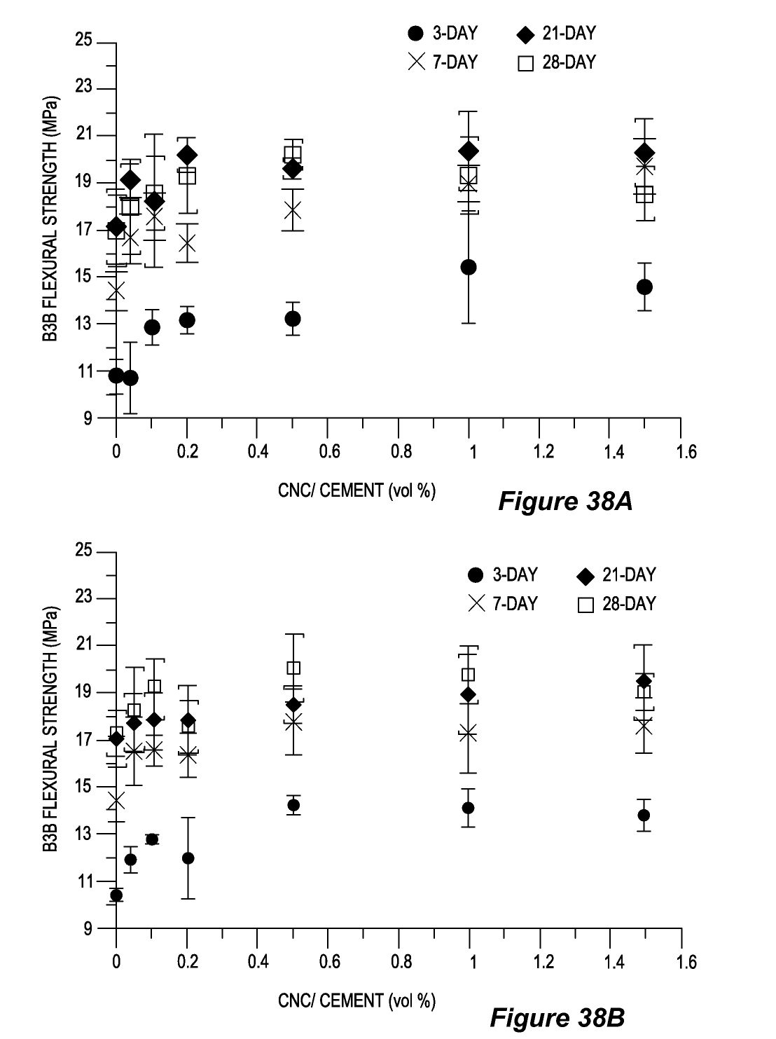

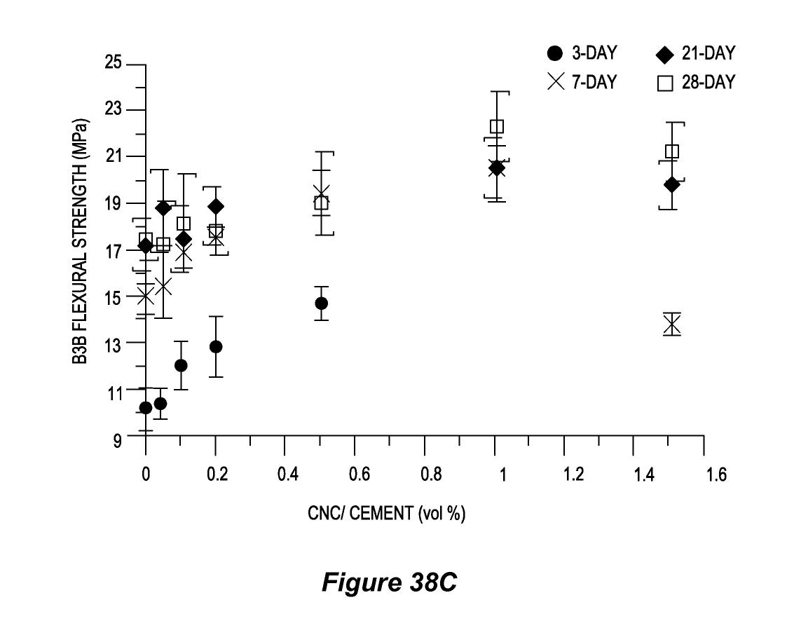

FIG. 36 shows the B3B flexural data of the cement pastes with freeze dried CNC powders at different ages. FIG. 37 shows the strength data with different ultrasonication durations and FIG. 38 provides the results of the mixtures with different amount of CNC/WRA weight ratios. From the results, it can be concluded as follows.

(1) The freeze dried CNC materials show similar strength improvements as the suspension CNC that the peak strength (20˜30% improvement) is reached at the concentration about 0.2% and then drops above that. As a result it does not matter if one uses an aqueous suspension or a dried CNC powder for mixing with cement because the resulting strengths do not make a significant difference. This is a huge benefit for the industrial large scale productions, as the transportation and storage cost will be significantly lowered dealing with dry CNC power compared to an aqueous form. Other than that, if the freeze dried CNC materials can be densified without compromising the performance of the cement composites, the cost can be further lowered, given the successful example of the densified silica fume in the cement and concrete industry.

(2) Cement pastes with ultrasonicated CNCs show much higher strengths than the previous two groups for all ages and concentrations. More important, with high concentration of CNC, i.e., 1.0% and 1.5%, the strength continues to increase rather than decrease, which is not same as what was seen for the suspension and freeze dried CNC cement pastes. This means the CNC agglomerations are significantly reduced by ultrasonication that they are no longer in the cement paste acting as a stress concentration when a loading is applied. However, it is shown earlier that the cumulative heats or the DOHs are very close for cement pastes with ultrasonicated or non-ultrasonicated CNCs. Along with the strength data here, one explanation is that the agglomerations are reduced significantly while the total amount of CNCs on the cement surface (settled CNCs) is not significantly changed, rather they are more uniformly distributed on the surface.

(3) The WRA ADVA 140 did not show much promise in dispersing the CNCs. The strengths results did not show more improvements from those without WRA.

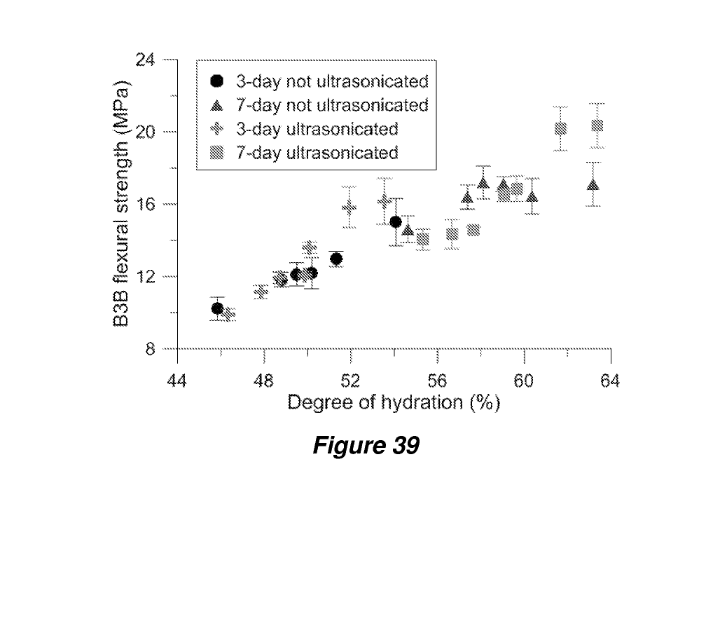

FIG. 39 shows the relationship between the B3B flexural strengths and the DOH calculated from IC at the ages of 3 and 7 days. The overall trend, as expected, shows an increase in strength with higher DOH. Comparing the trends between the non-ultrasonicated and ultrasonicated systems, however, the increase for latter is much higher than the former. This is most clear for the 7-day data that the non-ultrasonicated system reaches a plateau at the DOH about 58% and then the strength has little further improvement, while for the ultrasonicated data, the strength keeps increasing. This is because the agglomerations were broken by the ultrasonications, and hence at the high concentration regions, the strengths were no longer compromised by the stress concentrations, but determined mainly by the DOH.

Conclusions.

This example focuses on reducing the agglomeration of CNCs for the cement pastes via ultrasonication and examines how dispersion of CNCs changes the microstructural properties as well as the mechanical performance of the cement pastes at the macro-level. For CNCs in DI water, a critical concentration about 1.35% is found with rheological measurements, which agrees very well with the theoretical value 1.38%. When CNCs are in a simulated cement pore solution, the critical concentration is lowered to around 0.18% due to the surface charges. Above this critical concentration the agglomeration starts prevailing and strength decreases.

After the ultrasonication processing, the dispersed CNCs improve the strength of the cement pastes by up to 50%, which is much greater than the previously found improvement of 20-30% with the non-ultrasonicated CNCs. However the IC results show that the ultrasonication does not change the hydration process or the DOH of the cement pastes significantly. Moreover the concentration of the settled CNCs on the cement surface is found to be relatively unchanged by ultrasonication. This indicates that CNC agglomerations are reduced via the ultrasonication, but most CNCs are still on the cement surface and the only difference is they are more uniformly distributed.

Nanoindentation results show that the reduced modulus at the interfacial region is increased with CNCs and this may be explained by the high modulus of the CNCs. From the EDX results, it was found that hardened cement pastes with CNCs have significantly higher oxygen concentrations at the interface between the unhydrated cement particles and the matrix phase compared with the plain cement paste, and this quantitatively verifies the CNC-rich region.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

1. A cement paste composition comprising cement, water, and cellulose nanocrystals;
wherein the cellulose nanocrystals are present in an amount of about 0.04 volume % to about 5 volume %, the cellulose nanocrystals are substantially evenly dispersed throughout the cement, and the presence of the cellulose nanocrystals results in an increased degree of hydration and cumulative heat evolution in comparison to their absence, thereby resulting in a higher total cure of the cement paste composition upon curing.

2. The composition of claim 1 wherein the length of the cellulose nanocrystals is less than about 300 nm.

3. The composition of claim 2 wherein the diameter of the cellulose nanocrystals is less than about 15 nm.

4. The composition of claim 3 wherein the length of the cellulose nanocrystals is less than about 220 nm and the diameter of the cellulose nanocrystals is less than about 10 nm.

5. The composition of claim 4 wherein the composition does not contain a surfactant.

6. The composition of claim 5 wherein the flexural strength of the composition upon curing and hardening is increased by at least 10% compared to a corresponding composition that lacks the cellulose nanocrystals, as determined by ball-on-three-ball flexural strength analysis.

7. The composition of claim 6 wherein the flexural strength of the composition upon curing and hardening is increased by at least 20%.

8. The composition of claim 6 wherein the flexural strength of the composition upon curing and hardening is increased by at least 25%.

9. The composition of claim 1 wherein the cellulose nanocrystals are present in an amount of about 0.15 volume % to about 0.25 volume %.

10. The composition of claim 1 wherein the cement paste composition has a reduced yield point and increased plasticization and workability.

11. A method of reducing the amount of water necessary to maintain a cement paste viscosity comprising combining cellulose nanocrystals, cement, and water, to provide a resulting composition that includes cellulose nanocrystals in an amount of about 0.04 volume % to about 5 volume %, and dispersing the cellulose nanocrystals in the cement and water, thereby providing a cement paste composition that maintains a lower viscosity relative to a corresponding cement paste composition that does not include cellulose nanocrystals.

12. The method of claim 11 further comprising sonicating the combination of cellulose nanocrystals, cement, and water, resulting in greater dispersion of the cellulose nanocrystals in the cement paste composition.

13. The method of claim 12 wherein the length of the cellulose nanocrystals is about 100 nm to about 300 nm, and the diameter of the cellulose nanocrystals is about 3 nm to about 15 nm.

14. The method of claim 13 wherein upon curing and hardening, the cement paste composition is at least about 40% stronger than a corresponding composition that does not include the cellulose nanocrystals.

15. The method of claim 12 wherein the sonication comprises ultrasonication.

16. The method of claim 11 wherein the method increases the flexural strength of a cured cement composition upon combining cellulose nanocrystals, cement, and water, to provide a resulting cement paste composition that includes cellulose nanocrystals in an amount of about 0.04 volume % to about 5 volume %, and dispersing the cellulose nanocrystals in the cement and water, thereby providing a cement paste composition that has increased flexural strength compared to a corresponding composition that does not include the cellulose nanocrystals.

17. The composition of claim 16 wherein the length of the cellulose nanocrystals is about 100 nm to about 300 nm, and the diameter of the cellulose nanocrystals is about 3 nm to about 15 nm; and wherein the cement paste composition has a reduced yield point and increased plasticization and workability.

18. (canceled)

19. A cement composition comprising cement and cellulose nanocrystals, and optionally water;
wherein the cellulose nanocrystals are present in an amount of about 0.04 volume % to about 5 volume %, the cellulose nanocrystals are substantially evenly dispersed throughout the cement, and the presence of the cellulose nanocrystals result in an increased degree of hydration and cumulative heat evolution in comparison to their absence when combined with water, thereby resulting in a higher total cure of a resulting cement paste composition upon curing.

20. The composition of claim 19 wherein the length of the cellulose nanocrystals is about 100 nm to about 300 nm, and the diameter of the cellulose nanocrystals is about 3 nm to about 15 nm.

21. A composition comprising a cement paste composition as described in claim 1 wherein the composition is concrete, self-compacting concrete, mortar, or grout.
